(19) United States
(12) Patent Application Publication
(10) Pub. No.: US 2026/0101057 A1
(43) Pub. Date: Apr. 9, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Wenbin YIN, Beijing (CN); Zhipin DENG, Beijing (CN); Kai ZHANG, Los Angeles, CA (US); Li ZHANG, Los Angeles, CA (US)

(21) Appl. No.: 19/406,615

(22) Filed: Dec. 2, 2025

Related U.S. Application Data
(63) Continuation of application No. PCT/CN2024/096389, filed on May 30, 2024.

(30) Foreign Application Priority Data
Jun. 2, 2023 (WO) PCT/CN2023/098172

(51) Int. Cl. H04N 19/463; H04N 19/105; H04N 19/176; H04N 19/196; H04N 19/593; H04N 19/70

(52) U.S. Cl. CPC H04N 19/463; H04N 19/105; H04N 19/176; H04N 19/196; H04N 19/593; H04N 19/70

(57) ABSTRACT

Embodiments of the present disclosure provide a solution for video processing. A method for video processing is proposed. In the method, for a conversion between a current video unit of a video and a bitstream of the video, a model parameter inheritance for a coding tool is performed, the coding tool comprising at least one of: a cross-component model based residual coding (CCRM) tool, an intra template matching prediction (intraTMP) filter tool, or an intra block copy (IBC) filter tool, the model parameter inheritance comprising at least one of: a history based model parameter inheritance, a temporal based model parameter inheritance, or a spatial based model parameter inheritance. The conversion is performed based on the model parameter inheritance.

### CROSS REFERENCE TO RELATED APPLICATIONS

This application is a continuation of International Application No. PCT/CN2024/096389, filed on May 30, 2024, which claims the benefit of International Application No. PCT/CN2023/098172 filed on Jun. 2, 2023. The entire contents of these applications are hereby incorporated by reference in their entireties.

### FIELDS

Embodiments of the present disclosure relate generally to video processing techniques, and more particularly, to model parameter inheritance.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: performing, for a conversion between a current video unit of a video and a bitstream of the video, a model parameter inheritance for a coding tool, the coding tool comprising at least one of: a cross-component model based residual coding (CCRM) tool, an intra template matching prediction (intraTMP) filter tool, or an intra block copy (IBC) filter tool, the model parameter inheritance comprising at least one of: a history based model parameter inheritance, a temporal based model parameter inheritance, or a spatial based model parameter inheritance; and performing the conversion based on the model parameter inheritance. The method in accordance with the first aspect of the present disclosure uses the model parameter inheritance for video coding, and thus improves the coding efficiency.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: performing a model parameter inheritance for a coding tool, the coding tool comprising at least one of: a cross-component model based residual coding (CCRM) tool, an intra template matching prediction (intraTMP) filter tool, or an intra block copy (IBC) filter tool, the model parameter inheritance comprising at least one of: a history based model parameter inheritance, a temporal based model parameter inheritance, or a spatial based model parameter inheritance; and generating the bitstream based on the model parameter inheritance.

In a fifth aspect, a method for storing a bitstream of a video is proposed. The method comprises: performing a model parameter inheritance for a coding tool, the coding tool comprising at least one of: a cross-component model based residual coding (CCRM) tool, an intra template matching prediction (intraTMP) filter tool, or an intra block copy (IBC) filter tool, the model parameter inheritance comprising at least one of: a history based model parameter inheritance, a temporal based model parameter inheritance, or a spatial based model parameter inheritance; generating the bitstream based on the model parameter inheritance; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates nominal vertical and horizontal locations of 4:2:2 luma and chroma samples in a picture;

FIG. 5 illustrates an example of encoder block diagram;

FIG. 6 illustrates a picture with 18 by 12 luma CTUs that is partitioned into 12 tiles and 3 raster-scan slices;

FIG. 7 illustrates a picture with 18 by 12 luma CTUs that is partitioned into 24 tiles and 9 rectangular slices;

FIG. 8 illustrates a picture is partitioned into 4 tiles, 11 bricks, and 4 rectangular slices;

FIG. 9A-FIG. 9C illustrate examples of CTBs crossing picture borders, respectively;

FIG. 10 illustrates 67 intra prediction modes;

FIG. 11 illustrates an illustration of picture samples and horizontal and vertical block boundaries on the 8×8 grid, and the nonoverlapping blocks of the 8×8 samples, which can be deblocked in parallel;

FIG. 12 illustrates pixels involved in filter on/off decision and strong/weak filter switch;

FIG. 13A-FIG. 13C illustrate filter shapes for ALF, respectively;

FIG. 14A-FIG. 14C illustrate relative coordinator for the 5×5 diamond filter support, respectively;

FIG. 15 illustrates examples of relative coordinates for the 5×5 diamond filter support;

FIG. 16 illustrates spatial part of the filter;

FIG. 17 illustrates reference area used to derive the filter coefficients;

FIG. 18 illustrates an example of filter shape;

FIG. 19 illustrates a flowchart of a method for video processing in accordance with embodiments of the present disclosure;

FIG. 20 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

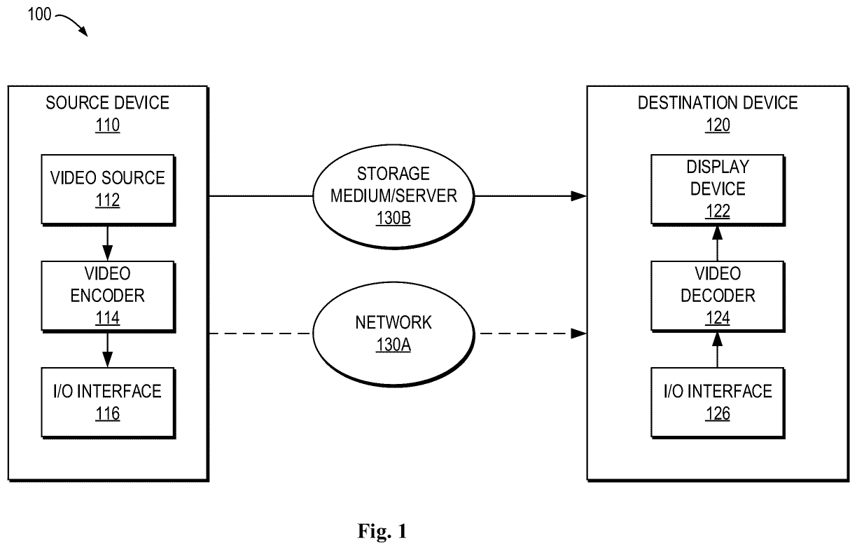

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

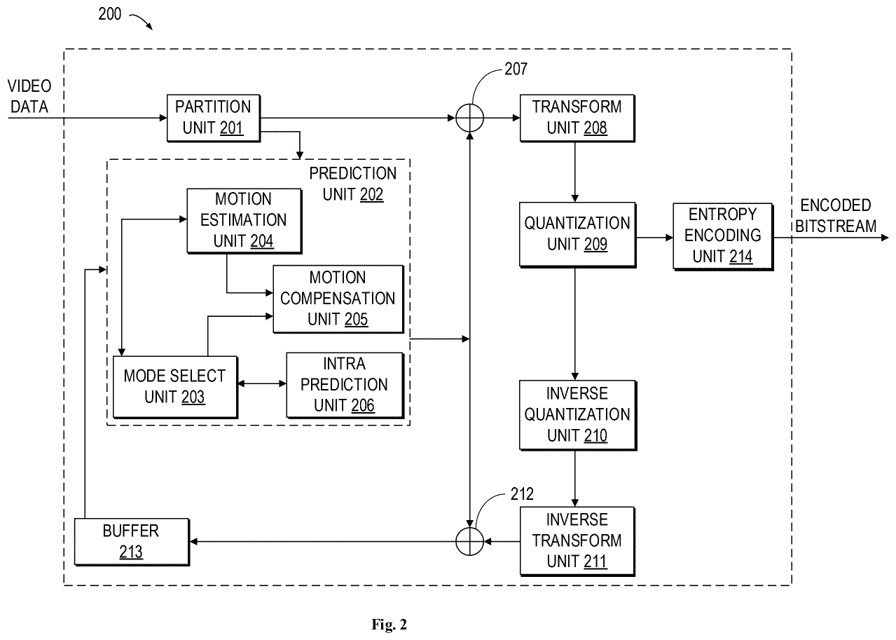

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

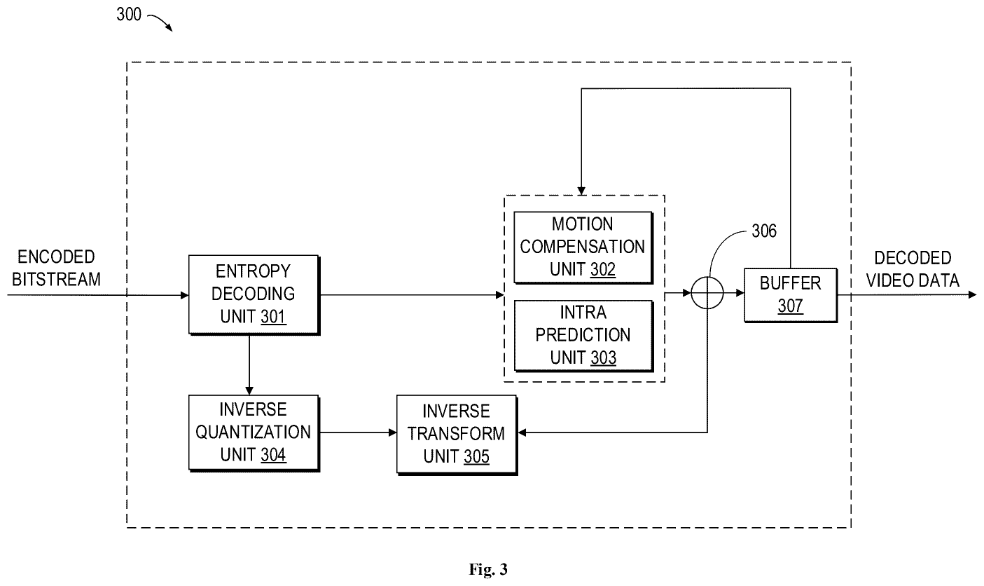

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video coding technologies. Specifically, it is related to in-loop filter and other coding tools in image/video coding. The ideas may be applied individually or in various combination, to any existing video coding standard or non-standard video codec like High Efficiency Video Coding (HEVC) and Versatile Video Coding (VVC). The proposed ideas may be also applicable to future video coding standards or video codec.

### 2. Abbreviations

AVC Advanced Video Coding
CPB Coded Picture Buffer
CRA Clean Random Access
CTU Coding Tree Unit
CVS Coded Video Sequence
DPB Decoded Picture Buffer
DPS Decoding Parameter Set
GCI General Constraints Information
HEVC High Efficiency Video Coding
JEM Joint Exploration Model
MCTS Motion-Constrained Tile Sets
NAL Network Abstraction Layer
OLS Output Layer Set
PH Picture Header
PPS Picture Parameter Set
PTL Profile, Tier and Level
PU Picture Unit
RRP Reference Picture Resampling
RBSP Raw Byte Sequence Payload
SEI Supplemental Enhancement Information
SH Slice Header
SPS Sequence Parameter Set
VCL Video Coding Layer
VPS Video Parameter Set
VTM VVC Test Model
VUI Video Usability Information
VVC Versatile Video Coding
TU Transform Unit
CU Coding Unit
DF Deblocking Filter
SAO Sample Adaptive Offset
ALF Adaptive Loop Filter
CBF Coding Block Flag
QP Quantization Parameter
RDO Rate Distortion Optimization
BF Bilateral Filter
GDR Gradual Decoding Refresh.

### 3. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. Since then, many new methods have been adopted by JVET and put into the reference software named Joint Exploration Model (JEM). The JVET meeting is concurrently held once every quarter, and the new coding standard is targeting at 50% bitrate reduction as compared to HEVC. The new video coding standard was officially named as Versatile Video Coding (VVC) in the April 2018 JVET meeting, and the first version of VVC test model (VTM) was released at that time. As there are continuous effort contributing to VVC standardization, new coding techniques are being adopted to the VVC standard in every JVET meeting. The VVC working draft and test model VTM are then updated after every meeting.

The latest version of VVC draft, i.e., Versatile Video Coding (Draft 10) may be found at: https://jvet-experts.org/doc_end_user/documents/19_Teleconference/wg11/JVET-52001-v17.zip.

The latest reference software of VVC, named as VTM, could be found at: https://vcgit.hhi.fraunhofer.de/jvet-u-ee2/VVCSoftware_VTM/-/treeNTM-11.2.

ITU-T VCEG (Q6/16) and ISO/IEC MPEG (JTC 1/SC 29/WG 11) are studying the potential need for standardization of future video coding technology with a compression capability that significantly exceeds that of the current VVC standard. Such future standardization action could either take the form of extended extension(s) of VVC or an entirely new standard. The groups are working together on this exploration activity in a joint-collaboration effort known as the Joint Video Exploration Team (JVET) to evaluate compression technology designs proposed by their experts in this area. The first Exploration Experiments (EE) were established in JVET meeting during 6-15 Jan. 2021 and the reference software named as Enhanced Compression Model (ECM). The test model ECM is updated after every JVET meeting.

### 3.1. Color Space and Chroma Subsampling

Color space, also known as the color model (or color system), is an abstract mathematical model which simply describes the range of colors as tuples of numbers, typically as 3 or 4 values or color components (e.g. RGB). Basically speaking, color space is an elaboration of the coordinate system and sub-space.

For video compression, the most frequently used color spaces are YCbCr and RGB.

YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.

Chroma subsampling is the practice of encoding images by implementing less resolution for chroma information than for luma information, taking advantage of the human visual system's lower acuity for color differences than for luminance.

3.1.1. 4:4:4

Each of the three Y′CbCr components have the same sample rate, thus there is no chroma subsampling. This scheme is sometimes used in high-end film scanners and cinematic postproduction.

3.1.2. 4:2:2

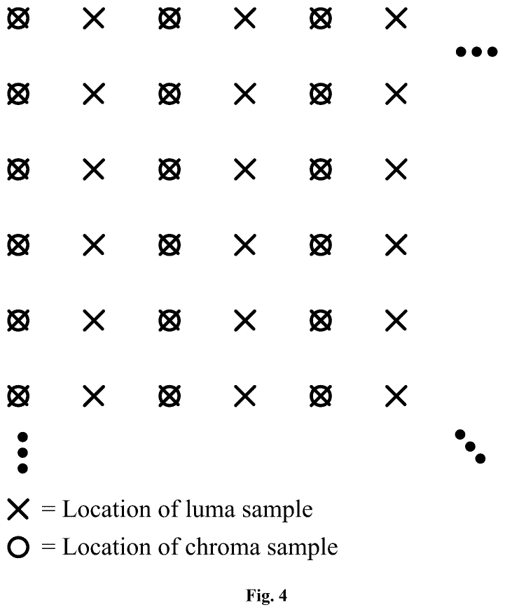

The two chroma components are sampled at half the sample rate of luma: the horizontal chroma resolution is halved while the vertical chroma resolution is unchanged. This reduces the bandwidth of an uncompressed video signal by one-third with little to no visual difference. An example of nominal vertical and horizontal locations of 4:2:2 color format is depicted in FIG. 4 in VVC working draft. FIG. 4 illustrates nominal vertical and horizontal locations of 4:2:2 luma and chroma samples in a picture.

3.1.3. 4:2:0

In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.
In MPEG-2, Cb and Cr are cosited horizontally. Cb and Cr are sited between pixels in the vertical direction (sited interstitially).
In JPEG/JFIF, H.261, and MPEG-1, Cb and Cr are sited interstitially, halfway between alternate luma samples.
In 4:2:0 DV, Cb and Cr are co-sited in the horizontal direction. In the vertical direction, they are co-sited on alternating lines.

TABLE 3-1
SubWidthC and SubHeightC values derived from chroma_{—}
format_idc and separate_colour_plane_flag

| chroma_{—} | separate_colour_{—} | Chroma | | |
|---|---|---|---|---|
| format_idc | plane_flag | format | SubWidthC | SubHeightC |
| 0 | 0 | Mono- | 1 | 1 |
| | | chrome | | |
| 1 | 0 | 4:2:0 | 2 | 2 |
| 2 | 0 | 4:2:2 | 2 | 1 |
| 3 | 0 | 4:4:4 | 1 | 1 |
| 3 | 1 | 4:4:4 | 1 | 1 |

### 3.2. Coding Flow of a Typical Video Codec

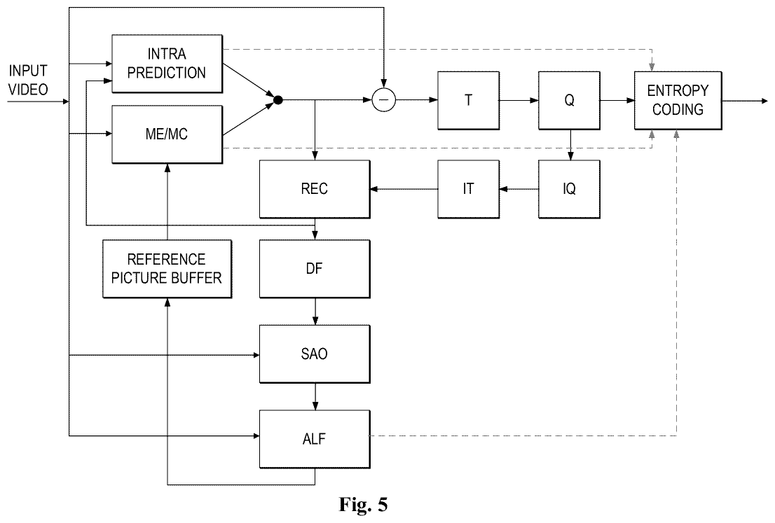

FIG. 5 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signalling the offsets and filter coefficients. ALF is located at the last processing stage of each picture and can be regarded as a tool trying to catch and fix artifacts created by the previous stages.

### 3.3. Definitions of Video/Coding Units

A picture is divided into one or more tile rows and one or more tile columns. A tile is a sequence of CTUs that covers a rectangular region of a picture.

A tile is divided into one or more bricks, each of which consisting of a number of CTU rows within the tile.

A tile that is not partitioned into multiple bricks is also referred to as a brick. However, a brick that is a true subset of a tile is not referred to as a tile.

A slice either contains several tiles of a picture or several bricks of a tile.

Two modes of slices are supported, namely the raster-scan slice mode and the rectangular slice mode. In the raster-scan slice mode, a slice contains a sequence of tiles in a tile raster scan of a picture. In the rectangular slice mode, a slice contains a number of bricks of a picture that collectively form a rectangular region of the picture.

The bricks within a rectangular slice are in the order of brick raster scan of the slice.

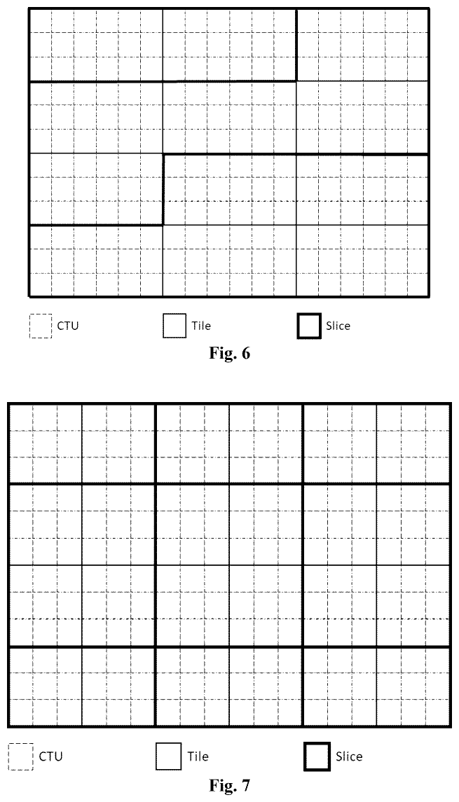

FIG. 6 illustrates a picture with 18 by 12 luma CTUs that is partitioned into 12 tiles and 3 raster-scan slices. FIG. 6 shows an example of raster-scan slice partitioning of a picture, where the picture is divided into 12 tiles and 3 raster-scan slices.

FIG. 7 illustrates a picture with 18 by 12 luma CTUs that is partitioned into 24 tiles and 9 rectangular slices. FIG. 7 in the VVC specification shows an example of rectangular slice partitioning of a picture, where the picture is divided into 24 tiles (6 tile columns and 4 tile rows) and 9 rectangular slices.

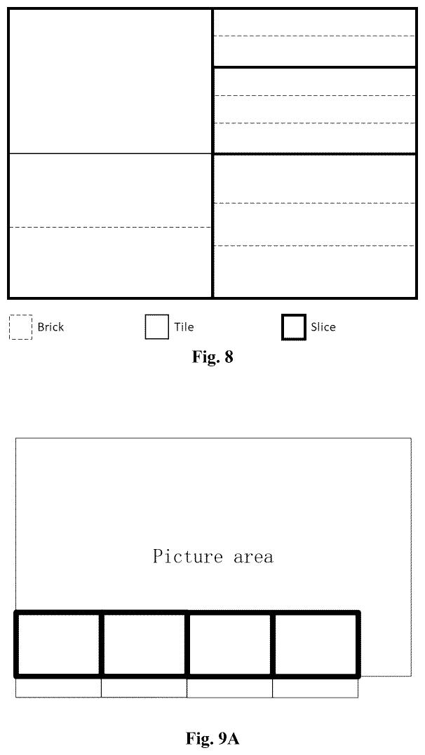

FIG. 8 illustrates a picture is partitioned into 4 tiles, 11 bricks, and 4 rectangular slices. FIG. 8 in the VVC specification shows an example of a picture partitioned into tiles, bricks, and rectangular slices, where the picture is divided into 4 tiles (2 tile columns and 2 tile rows), 11 bricks (the top-left tile contains 1 brick, the top-right tile contains 5 bricks, the bottom-left tile contains 2 bricks, and the bottom-right tile contain 3 bricks), and 4 rectangular slices.

### 3.3.1. CTU/CTB Sizes

In VVC, the CTU size, signaled in SPS by the syntax element log 2_ctu_size_minus2, could be as small as 4×4.

Sequence parameter set RBSP syntax

| | Descriptor |
|---|---|
| seq_parameter_set_rbsp( ) { | |
| sps_decoding_parameter_set_id | u(4) |
| sps_video_parameter_set_id | u(4) |
| sps_max_sub_layers_minus1 | u(3) |
| sps_reserved_zero_5bits | u(5) |
| profile_tier_level( sps_max_sub_layers_minus1 ) | |
| gra_enabled_flag | u(1) |
| sps_seq_parameter_set_id | ue(v) |
| chroma_format_idc | ue(v) |
| if( chroma_format_idc = = 3 ) | |
| separate_colour_plane_flag | u(1) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : sps_max_sub_layers_minus1 ); | |
| i <= sps_max_sub_layers_minus1; i++ ) { | |
| sps_max_dec_pic_buffering_minus1[ i ] | ue(v) |
| sps_max_num_reorder_pics[ i ] | ue(v) |
| sps_max_latency_increase_plus1[ i ] | ue(v) |
| } | |
| long_term_ref_pics_flag | u(1) |
| sps_idr_rpl_present_flag | u(1) |
| rpl1_same_as_rpl0_flag | u(1) |
| for( i = 0; i < !rpl1_same_as_rpl0_flag ? 2 : 1; i++ ) { | |
| num_ref_pic_lists_in_sps[ i ] | ue(v) |
| for( j = 0; j < num_ref_pic_lists_in_sps[ i ]; j++) | |
| ref_pic_list_struct( i, j ) | |
| } | |
| qtbtt_dual_tree_intra_flag | u(1) |
| log2_ctu_size_minus2 | ue(v) |
| log2_min_luma_coding_block_size_minus2 | ue(v) |
| partition_constraints_override_enabled_flag | u(1) |
| sps_log2_diff_min_qt_min_cb_intra_slice_luma | ue(v) |
| sps_log2_diff_min_qt_min_cb_inter_slice | ue(v) |
| sps_max_mtt_hierarchy_depth_inter_slice | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_max_mtt_hierarchy_depth_inter_slices != 0 ) { | |
| sps_log2_diff_max_bt_min_qt_inter_slice | ue(v) |
| sps_log2_diff_max_tt_min_qt_inter_slice | ue(v) |
| } | |
| if( qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if ( sps_max_mtt_hierarchy_depth_intra_slice_chroma != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| ... | |
| rbsp_trailing_bits( ) | |
| } | |

log 2_ctu_size_minus2 plus 2 specifies the luma coding tree block size of each CTU.

log 2__size_minus2 plus 2 specifies the minimum luma coding block size.

The variables CtbLog 2SizeY, CtbSizeY, MinCbLog 2SizeY, MinCbSizeY, MinTbLog 2SizeY, MaxTbLog 2SizeY, MinTbSizeY, MaxTbSizeY, PicWidthlnCtbsY, PicHeightInCtbsY, PicSizeInCtbsY, PicWidthInMinCbsY, PicHeightInMinCbsY, PicSizeInMinCbsY, PicSizeInSamplesY, PicWidthInSamplesC and PicHeightInSamplesC are derived as follows:

$$CtbLog 2 SizeY = log2\_ctu \_size \_minus2 + 2 \qquad ( 7 - 9 )$$

$$CtbSizeY = 1 ≪ CtbLog 2 SizeY \qquad ( 7 - 10 )$$

$$MinCbLog 2 SizeY = log2\_min \_luma \_coding \_block \_size \_minus2 + 2 \qquad ( 7 - 11 )$$

$$MinCbSizeY = 1 ≪ MinCbLog 2 SizeY \qquad ( 7 - 12 )$$

$$MinTbLog 2 SizeY = 2 \qquad ( 7 - 13 )$$

$$MaxTbLog 2 SizeY = 6 \qquad ( 7 - 14 )$$

$$MinTbSizeY = 1 ≪ MinTbLog 2 SizeY \qquad ( 7 - 15 )$$

$$MaxTbSizeY = 1 ≪ MaxTbLog 2 SizeY \qquad ( 7 - 16 )$$

$$PicWidthInCtbsY = Ceil ( pic\_width \_in \_luma \_samples \div CtbSizeY ) \qquad ( 7 - 17 )$$

$$PicHeightInCtbsY = Ceil ( pic\_height \_in \_luma \_samples \div CtbSizeY ) \qquad ( 7 - 18 )$$

$$PicSizeInCtbsY = PicWidthInCtbsY * PicHeightInCtbsY \qquad ( 7 - 19 )$$

$$PicWidthInMinCbsY = pic\_width \_in \_luma \_samples / MinCbSizeY \qquad ( 7 - 20 )$$

$$PicHeightInMinCbsY = pic\_height \_in \_luma \_samples / MinCbSizeY \qquad ( 7 - 21 )$$

$$PicSizeInMinCbsY = PicWidthInMinCbsY * PicHeightInMinCbsY \qquad ( 7 - 22 )$$

$$PicSizeInSamplesY = pic\_width \_in \_luma \_samples * pic\_height \_in \_luma \_samples \qquad ( 7 - 23 )$$

$$PicWidthInSamplesC = pic\_width \_in \_luma \_samples / SubWidthC \qquad ( 7 - 24 )$$

$$PicHeightInSamplesC = pic\_height \_in \_luma \_samples / SubHeightC . \qquad ( 7 - 25 )$$

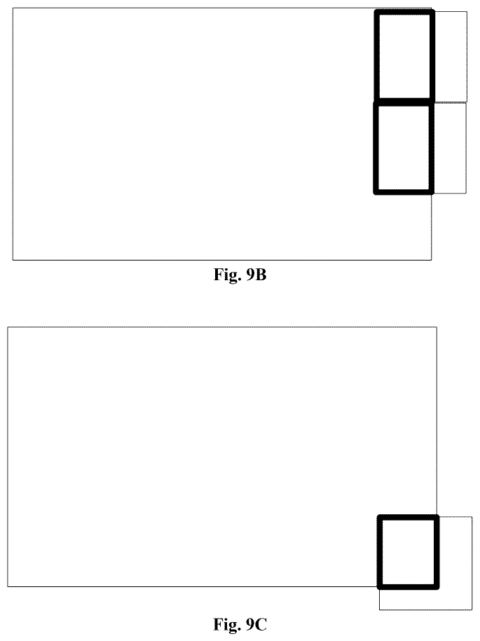

3.3.2. CTUs in One Picture Suppose the CTB/LCU size indicated by M×N (typically M is equal to N, as defined in HEVC/VVC), and for a CTB located at picture (or tile or slice or other kinds of types, picture border is taken as an example) border, K×L samples are within picture border wherein either K<M or L<N. FIG. 9A-FIG. 9C illustrate examples of CTBs crossing picture borders, respectively. FIG. 9A illustrates CTBs crossing the bottom picture border. FIG. 9B illustrates CTBs crossing the right picture border. FIG. 9C illustrates CTBs crossing the right bottom picture border. For those CTBs as depicted in FIG. 9A-FIG. 9C, the CTB size is still equal to M×N, however, the bottom boundary/right boundary of the CTB is outside the picture.

### 3.4. Intra Prediction

To capture the arbitrary edge directions presented in natural video, the number of directional intra modes is extended from 33, as used in HEVC, to 65. The extended directional modes are depicted as dotted arrows, and the planar and DC modes remain the same. These denser directional intra prediction modes apply for all block sizes and for both luma and chroma intra predictions.

FIG. 10 illustrates 67 intra prediction modes. Conventional angular intra prediction directions are defined from 45 degrees to −135 degrees in clockwise direction as shown in FIG. 10. In VTM, several conventional angular intra prediction modes are adaptively replaced with wide-angle intra prediction modes for the non-square blocks. The replaced modes are signalled using the original method and remapped to the indexes of wide angular modes after parsing. The total number of intra prediction modes is unchanged, i.e., 67, and the intra mode coding is unchanged.

In the HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 3.5. Inter Prediction

For each inter-predicted CU, motion parameters consisting of motion vectors, reference picture indices and reference picture list usage index, and extended information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and extended schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

### 3.6. Deblocking Filter

Deblocking filtering typical in-loop filter in video codec. In VVC, the deblocking filtering process is applied on CU boundaries, transform subblock boundaries and prediction subblock boundaries. The prediction subblock boundaries include the prediction unit boundaries introduced by the SbTMVP (Subblock based Temporal Motion Vector prediction) and affine modes, and the transform subblock boundaries include the transform unit boundaries introduced by SBT (Subblock transform) and ISP (Intra Sub-Partitions) modes and transforms due to implicit split of large CUs. As done in HEVC, the processing order of the deblocking filter is defined as horizontal filtering for vertical edges for the entire picture first, followed by vertical filtering for horizontal edges. This specific order enables either multiple horizontal filtering or vertical filtering processes to be applied in parallel threads or can still be implemented on a CTB-by-CTB basis with only a small processing latency.

The vertical edges in a picture are filtered first. Then the horizontal edges in a picture are filtered with samples modified by the vertical edge filtering process as input. The vertical and horizontal edges in the CTBs of each CTU are processed separately on a coding unit basis. The vertical edges of the coding blocks in a coding unit are filtered starting with the edge on the left-hand side of the coding blocks proceeding through the edges towards the right-hand side of the coding blocks in their geometrical order. The horizontal edges of the coding blocks in a coding unit are filtered starting with the edge on the top of the coding blocks proceeding through the edges towards the bottom of the coding blocks in their geometrical order.

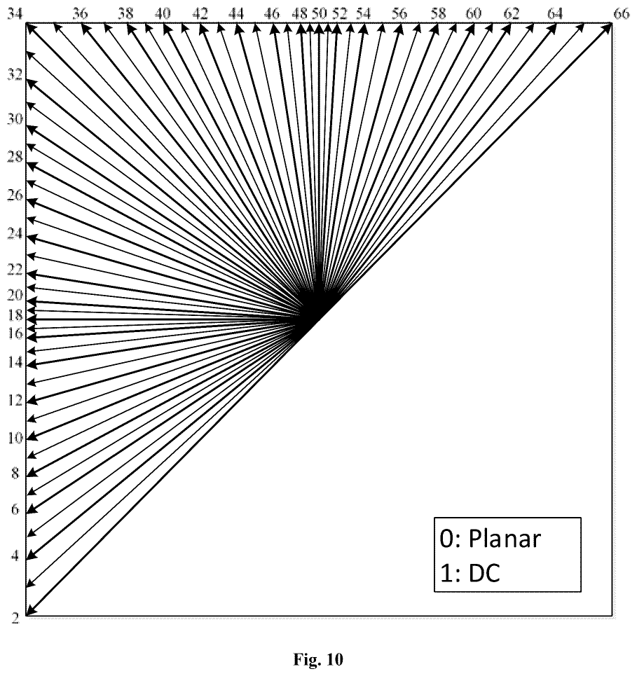

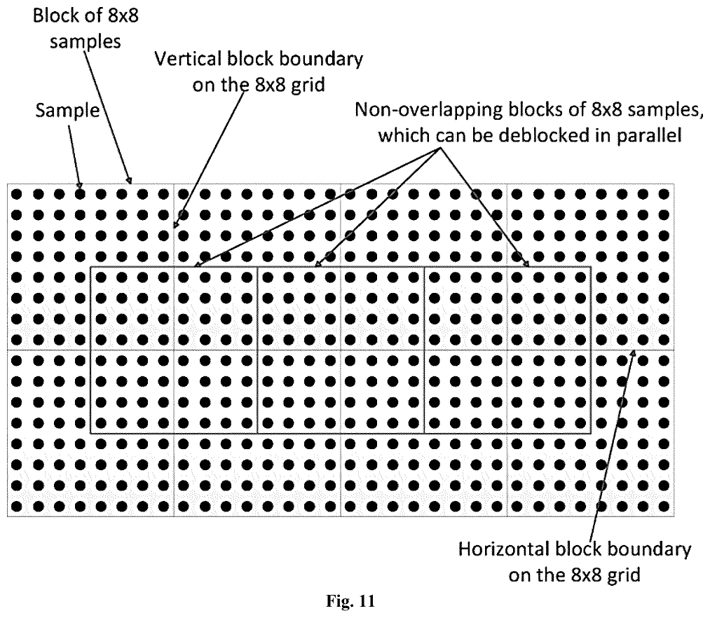

FIG. 11 illustrates an illustration of picture samples and horizontal and vertical block boundaries on the 8×8 grid, and the nonoverlapping blocks of the 8×8 samples, which can be deblocked in parallel.

### 3.6.1. Boundary Decision

Filtering is applied to 8×8 block boundaries. In addition, it must be a transform block boundary or a coding subblock boundary (e.g., due to usage of Affine motion prediction, ATMVP). For those which are not such boundaries, filter is disabled.

### 3.6.2. Boundary Strength Calculation

For a transform block boundary/coding subblock boundary, if it is located in the 8×8 grid, it may be filtered and the selling of bS[xDᵢ][yDⱼ] (wherein [xDᵢ][yDⱼ] denotes the coordinate) for this edge is defined as below.

TABLE 3-2
Boundary strength (when SPS IBC is disabled)

| Priority | Conditions | Y | U | V |
|---|---|---|---|---|
| 5 | At least one of the adjacent blocks is intra | 2 | 2 | 2 |
| 4 | TU boundary and at least one of the adjacent | 1 | 1 | 1 |
| | blocks has non-zero transform coefficients | | | |
| 3 | Reference pictures or number of MVs (1 for | 1 | N/A | N/A |
| | uni-prediction, 2 for bi-prediction) of the | | | |
| | adjacent blocks are different | | | |
| 2 | Absolute difference between the motion | 1 | N/A | N/A |
| | vectors of same reference picture that belong | | | |
| | to the adjacent blocks is greater than or equal | | | |
| | to one integer luma sample | | | |
| 1 | Otherwise | 0 | 0 | 0 |

TABLE 3-3
Boundary strength (when SPS IBC is enabled)

| Priority | Conditions | Y | U | V |
|---|---|---|---|---|
| 8 | At least one of the adjacent blocks is intra | 2 | 2 | 2 |
| 7 | TU boundary and at least one of the adjacent | 1 | 1 | 1 |
| | blocks has non-zero transform coefficients | | | |
| 6 | Prediction mode of adjacent blocks is | 1 | | |
| | different (e.g., one is IBC, one is inter) | | | |
| 5 | Both IBC and absolute difference between | 1 | N/A | N/A |
| | the motion vectors that belong to the | | | |
| | adjacent blocks is greater than or equal to | | | |
| | one integer luma sample | | | |
| 4 | Reference pictures or number of MVs (1 for | 1 | N/A | N/A |
| | uni-prediction, 2 for bi-prediction) of the | | | |
| | adjacent blocks are different | | | |
| 3 | Absolute difference between the motion | 1 | N/A | N/A |
| | vectors of same reference picture that | | | |
| | belong to the adjacent blocks is greater | | | |
| | than or equal to one integer luma sample | | | |
| 1 | Otherwise | 0 | 0 | 0 |

### 3.6.3. Deblocking Decision for Luma Component

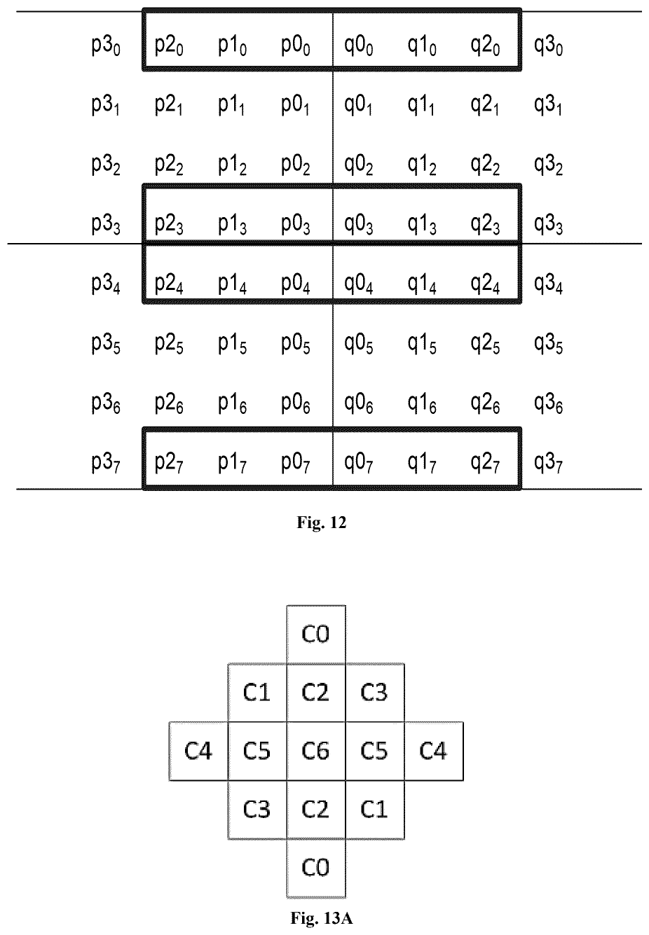

FIG. 12 illustrates pixels involved in filter on/off decision and strong/weak filter switch.

Wider-stronger luma filter is filters are used only if all the Condition1, Condition2 and Condition 3 are TRUE.

The condition 1 is the “large block condition”. This condition detects whether the samples at P-side and Q-side belong to large blocks, which are represented by the variable bSidePisLargeBlk and bSideQisLargeBlk respectively. The bSidePisLargeBlk and bSideQisLargeBlk are defined as follows.
bSidePisLargeBlk=((edge type is vertical and p₀ belongs to CU with width>=32∥(edge type is horizontal and p₀ belongs to CU with height>=32))?TRUE:FALSE,
bSideQisLargeBlk=((edge type is vertical and q₀ belongs to CU with width>=32)∥(edge type is horizontal and q₀ belongs to CU with height>=32))?TRUE:FALSE.

Based on bSidePisLargeBlk and bSideQisLargeBlk, the condition 1 is defined as follows.

Condition1=(bSidePisLargeBlk∥bSidePisLargeBlk)?TRUE:FALSE.

Next, if Condition 1 is true, the condition 2 will be further checked. First, the following variables are derived:
dp0, dp3, dq0, dq3 are first derived as in HEVC
if (p side is greater than or equal to 32)

$$dp 0 = ( dp 0 + Abs ( p {5}_{0} - 2 * p {4}_{0} + p {3}_{0} ) + 1 ) ≫ 1$$

$$dp 3 = ( dp 3 + Abs ( p {5}_{3} - 2 * p {4}_{3} + p {3}_{3} ) + 1 ) ≫ 1$$

if (q side is greater than or equal to 32)

$$dq 0 = ( dq 0 + Abs ( q {5}_{0} - 2 * q {4}_{0} + q {3}_{0} ) + 1 ) ≫ 1$$

$$dq 3 = ( dq 3 + Abs ( q {5}_{3} - 2 * q {4}_{3} + q {3}_{3} ) + 1 ) ≫ 1.$$

Condition2=(d<β)?TRUE:FALSE.
where d=dp0+dq0+dp3+dq3.

If Condition1 and Condition2 are valid, whether any of the blocks uses sub-blocks is further checked:

```
If (bSidePisLargeBlk)
  {
    If (mode block P == SUBBLOCKMODE)
      Sp =5
      else
      Sp =7
}
else
  Sp = 3
If (bSideQisLargeBlk)
    {
    If (mode block Q == SUBBLOCKMODE)
        Sq =5
      else
        Sq =7
    }
else
  Sq = 3.
```

Finally, if both the Condition 1 and Condition 2 are valid, the proposed deblocking method will check the condition 3 (the large block strong filter condition), which is defined as follows.

In the Condition3 StrongFilterCondition, the following variables are derived:

```
dpq is derived as in HEVC.
sp₃ = Abs( p₃ − p₀ ), derived as in HEVC
if (p side is greater than or equal to 32)
    if(Sp==5)
      sp₃ = ( sp₃ + Abs( p₅ − p₃ ) + 1) >> 1
    else
      sp₃ = ( sp₃ + Abs( p₇ − p₃ ) + 1) >> 1
sq₃ = Abs( q₀ − q₃ ), derived as in HEVC
if (q side is greater than or equal to 32)
  If(Sq==5)
    sq₃ = ( sq₃ + Abs( q₅ − q₃ ) + 1) >> 1
  else
    sq₃ = ( sq₃ + Abs( q₇ − q₃ ) + 1) >> 1.
```

As in HEVC, StrongFilterCondition=(dpq is less than (β>>2), sp₃+sq₃ is less than (3*β>>5), and Abs(p₀−q₀) is less than (5*t_{C}+1)>>1)?TRUE: FALSE.

### 3.6.4. Stronger Deblocking Filter for Luma

Bilinear filter is used when samples at either one side of a boundary belong to a large block. A sample belonging to a large block is defined as when the width>=32 for a vertical edge, and when height>=32 for a horizontal edge.

The bilinear filter is listed below.

Block boundary samples pᵢ for i=0 to Sp-1 and qᵢ for j=0 to Sq-1 (pi and qi are the i-th sample within a row for filtering vertical edge, or the i-th sample within a column for filtering horizontal edge) in HEVC deblocking described above) are then replaced by linear interpolation as follows:

$${{p}_{i}}^{′} = ( {f}_{i} * {Middle}_{s , t} + ( 64 - {f}_{i} ) * {P}_{s} + 32 ) ≫ 6 ) , clipped to {p}_{i} \pm {tcPD}_{i}$$

$${{q}_{j}}^{′} = ( {g}_{j} * {Middle}_{s , t} + ( 64 - {g}_{j} ) * {Q}_{s} + 32 ) ≫ 6 ) , clipped to {q}_{j} \pm {tcPD}_{j}$$

where tcPDᵢ and tcPDⱼ term is a position dependent clipping described in Section 3.6.2 and gⱼ, fᵢ, Middle_{s,t}, Pₛ and Qₛ are given below.

### 3.6.5. Deblocking Decision for Chroma

The chroma strong filters are used on both sides of the block boundary. Here, the chroma filter is selected when both sides of the chroma edge are greater than or equal to 8 (chroma position), and the following decision with three conditions are satisfied: the first one is for decision of boundary strength as well as large block. The proposed filter can be applied when the block width or height which orthogonally crosses the block edge is equal to or larger than 8 in chroma sample domain. The second and third one is basically the same as for HEVC luma deblocking decision, which are on/off decision and strong filter decision, respectively.

In the first decision, boundary strength (bS) is modified for chroma filtering and the conditions are checked sequentially. If a condition is satisfied, then the remaining conditions with lower priorities are skipped.

Chroma deblocking is performed when bS is equal to 2, or bS is equal to 1 when a large block boundary is detected.

The second and third condition is basically the same as HEVC luma strong filter decision as follows.

In the second condition:
d is then derived as in HEVC luma deblocking.

The second condition will be TRUE when d is less than D.

In the third condition StrongFilterCondition is derived as follows:
dpq is derived as in HEVC.

$${sp}_{3} = Abs ( {p}_{3} - {p}_{0} ) , derived as in HEVC$$

$${sq}_{3} = Abs ( {q}_{0} - {q}_{3} ) , derived as in HEVC .$$

As in HEVC design, StrongFilterCondition=(dpq is less than (β>>2), sp₃+sq₃ is less than (β>>3), and Abs(p₀−g₀) is less than (5*t_{C}+1)>>1).

### 3.6.6. Strong Deblocking Filter for Chroma

The following strong deblocking filter for chroma is defined:

$${{p}_{2}}^{′} = ( 3 * {p}_{3} + 2 * {p}_{2} + {p}_{1} + {p}_{0} + {q}_{0} + 4 ) ≫ 3$$

$${{p}_{1}}^{′} = ( 2 * {p}_{3} + {p}_{2} + 2 * {p}_{1} + {p}_{0} + {q}_{0} + {q}_{1} + 4 ) ≫ 3$$

$${{p}_{0}}^{′} = ( {p}_{3} + {p}_{2} + {p}_{1} + 2 * {p}_{0} + {q}_{0} + {q}_{1} + {q}_{2} + 4 ) ≫ 3.$$

The proposed chroma filter performs deblocking on a 4×4 chroma sample grid.

### 3.6.7. Position Dependent Clipping

The position dependent clipping tcPD is applied to the output samples of the luma filtering process involving strong and long filters that are modifying 7, 5 and 3 samples at the boundary. Assuming quantization error distribution, it is proposed to increase clipping value for samples which are expected to have higher quantization noise, thus expected to have higher deviation of the reconstructed sample value from the true sample value.

For each P or Q boundary filtered with asymmetrical filter, depending on the result of decision-making, position dependent threshold table is selected from two tables (i.e., Tc7 and Tc3 tabulated below) that are provided to decoder as a side information:

$$Tc 7 = \{ 6 , 5 , 4 , 3 , 2 , 1 , 1 \} ; Tc 3 = \{ 6 , 4 , 2 \} ;$$

$$tcPD = ( Sp == 3 ) ? Tc 3 : Tc 7 ;$$

$$tcQD = ( Sq == 3 ) ? Tc 3 : Tc 7.$$

For the P or Q boundaries being filtered with a short symmetrical filter, position dependent threshold of lower magnitude is applied:

$$Tc 3 = \{ 3 , 2 , 1 \} .$$

Following defining the threshold, filtered p′ᵢ and q′ᵢ sample values are clipped according to tcP and tcQ clipping values:

$${{{{p ”}_{i} = Clip 3 ( p ’}_{i} + {tcP}_{i} , p ’}_{i} - {tcP}_{i} , p ’}_{i} ) ;$$

$${{{{q ”}_{j} = Clip 3 ( q ’}_{j} + {tcQ}_{j} , q ’}_{j} - {tcQ}_{j} , q ’}_{j} ) .$$

where p′ᵢ and q′ᵢ are filtered sample values, p″ᵢ and q″ⱼ are output sample value after the clipping and tcPᵢ tcPᵢ are clipping thresholds that are derived from the VVC tc parameter and tcPD and tcQD. The function Clip3 is a clipping function as it is specified in VVC.

### 3.6.8. Sub-Block Deblocking Adjustment

To enable parallel friendly deblocking using both long filters and sub-block deblocking the long filters is restricted to modify at most 5 samples on a side that uses sub-block deblocking (AFFINE or ATMVP or DMVR) as shown in the luma control for long filters. Extendedly, the sub-block deblocking is adjusted such that that sub-block boundaries on an 8×8 grid that are close to a CU or an implicit TU boundary is restricted to modify at most two samples on each side.

Following applies to sub-block boundaries that not are aligned with the CU boundary.

```
If (mode block Q == SUBBLOCKMODE && edge !=0) {
  if (!(implicitTU && (edge == (64 / 4))))
    if (edge == 2 || edge == (orthogonalLength − 2)
    || edge == (56 / 4) || edge == (72 / 4))
        Sp = Sq = 2;
      else
        Sp = Sq = 3;
  else
      Sp = Sq = bSideQisLargeBlk ? 5:3
}.
```

Where edge equal to 0 corresponds to CU boundary, edge equal to 2 or equal to orthogonalLength−2 corresponds to sub-block boundary 8 samples from a CU boundary etc. Where implicit TU is true if implicit split of TU is used.

### 3.7. Sample Adaptive Offset

Sample adaptive offset (SAO) is applied to the reconstructed signal after the deblocking filter by using offsets specified for each CTB by the encoder. The video encoder first makes the decision on whether or not the SAO process is to be applied for current slice. If SAO is applied for the slice, each CTB is classified as one of five SAO types as shown in Table. 3-1. The concept of SAO is to classify pixels into categories and reduces the distortion by adding an offset to pixels of each category. SAO operation includes edge offset (EO) which uses edge properties for pixel classification in SAO type 1 to 4 and band offset (BO) which uses pixel intensity for pixel classification in SAO type 5. Each applicable CTB has SAO parameters including sao_merge_left_flag, sao_merge_up_flag, SAO type and four offsets. If sao_merge_left_flag is equal to 1, the current CTB will reuse the SAO type and offsets of the CTB to the left. If sao_merge_up_flag is equal to 1, the current CTB will reuse SAO type and offsets of the CTB above.

TABLE 3-4
Specification of SAO type

| | sample adaptive offset type to be | |
|---|---|---|
| SAO type | used | Number of categories |
| 0 | None | 0 |
| 1 | 1-D 0-degree pattern edge offset | 4 |
| 2 | 1-D 90-degree pattern edge offset | 4 |
| 3 | 1-D 135-degree pattern edge offset | 4 |
| 4 | 1-D 45-degree pattern edge offset | 4 |
| 5 | band offset | 4 |

### 3.8. Adaptive Loop Filter

Adaptive loop filtering for video coding is to minimize the mean square error between original samples and decoded samples by using Wiener-based adaptive filter. The ALF is located at the last processing stage for each picture and can be regarded as a tool to catch and fix artifacts from previous stages. The suitable filter coefficients are determined by the encoder and explicitly signalled to the decoder. To achieve better coding efficiency, especially for high resolution videos, local adaptation is used for luma signals by applying different filters to different regions or blocks in a picture. In addition to filter adaptation, filter on/off control at coding tree unit (CTU) level is also helpful for improving coding efficiency. Syntax-wise, filter coefficients are sent in a picture level header called adaptation parameter set, and filter on/off flags of CTUs are interleaved at CTU level in the slice data. This syntax design not only supports picture level optimization but also achieves a low encoding latency.

### 3.8.1. Signaling of Parameters

According to ALF design in VTM, filter coefficients and clipping indices are carried in ALF APSs. An ALF APS can include up to 8 chroma filters and one luma filter set with up to 25 filters. An index is also included for each of the 25 luma classes. Classes having the same index share the same filter. By merging different classes, the num of bits required to represent the filter coefficients is reduced. The absolute value of a filter coefficient is represented using a 0^{th} order Exp-Golomb code followed by a sign bit for a non-zero coefficient. When clipping is enabled, a clipping index is also signalled for each filter coefficient using a two-bit fixed-length code. Up to 8 ALF APSs can be used by the decoder at the same time.

Filter control syntax elements of ALF in VTM include two types of information. First, ALF on/off flags are signalled at sequence, picture, slice and CTB levels. Chroma ALF can be enabled at picture and slice level only if luma ALF is enabled at the corresponding level. Second, filter usage information is signalled at picture, slice and CTB level, if ALF is enabled at that level. Referenced ALF APSs IDs are coded at a slice level or at a picture level if all the slices within the picture use the same APSs. Luma component can reference up to 7 ALF APSs and chroma components can reference 1 ALF APS. For a luma CTB, an index is signalled indicating which ALF APS or offline trained luma filter set is used. For a chroma CTB, the index indicates which filter in the referenced APS is used.

The data syntax elements of ALF associated to LUMA component in VTM are listed as follows:

| | Descriptor |
|---|---|
| alf_data( ) { | |
| alf_luma_filter_signal_flag | u(1) |
| if( alf_luma_filter_signal_flag ) { | |
| alf_luma_clip_flag | u(1) |
| alf_luma_num_filters_signalled_minus1 | ue(v) |
| if( alf_luma_num_filters_signalled_minus1 > 0 ) | |
| for( filtIdx = 0; filtIdx < NumAlfFilters; filtIdx++ ) | |
| alf_luma_coeff_delta_idx[ filtIdx ] | u(v) |
| for( sfIdx = 0; sfIdx <= alf_luma_num_filters_signalled_minus1; sfIdx++ ) | |
| for( j = 0; j < 12; j++ ) { | |
| alf_luma_coeff_abs[ sfIdx ][ j ] | ue(v) |
| if( alf luma_coeff_abs[ sfIdx ][ j ] ) | |
| alf_luma_coeff_sign[ sfIdx ][ j ] | u(1) |
| } | |
| if( alf_luma_clip_flag ) | |
| for( sfIdx = 0; sfIdx <= alf_luma_num_filters_signalled_minus1; sfIdx++ ) | |
| for( j = 0; j < 12; j++ ) | |
| alf_luma_clip_idx[ sfIdx ][ j ] | u(2) |
| } | |

alf_luma_filter_signal_flag equal to 1 specifies that a luma filter set is signalled. alf_luma_filter_signal_flag equal to 0 specifies that a luma filter set is not signalled.

alf_luma_clip_flag equal to 0 specifies that linear adaptive loop filtering is applied to the luma component. alf_luma_clip_flag equal to 1 specifies that non-linear adaptive loop filtering could be applied to the luma component.

alf_luma_num_filters_signalled_minus1 plus 1 specifies the number of adaptive loop filter classes for which luma coefficients can be signalled. The value of alf_luma_num_filters_signalled_minus1 shall be in the range of 0 to NumAlffilters−1, inclusive.

alf_luma_coeff_delta_idx[filtIdx] specifies the indices of the signalled adaptive loop filter luma coefficient deltas for the filter class indicated by filtIdx ranging from 0 to NumAlffilters−1. When alf_luma_coeff_delta_idx[filtIdx] is not present, it is inferred to be equal to 0. The length of alf_luma_coeff_delta_idx[filtIdx] is Ceil(Log 2(alf_luma_num_filters_signalled_minus1+1)) bits. The value of alf_luma_coeff_delta_idx[filtIdx] shall be in the range of 0 to alf_luma_num_filters_signalled_minus1, inclusive.

alf_luma_coeff_abs[sfIdx][j] specifies the absolute value of the j-th coefficient of the signalled luma filter indicated by sfIdx. When alf_luma_coeff_abs[sfIdx][j] is not present, it is inferred to be equal 0. The value of alf_luma_coeff_abs[sfIdx][j] shall be in the range of 0 to 128, inclusive.

alf_luma_coeff_sign[sfIdx][j] specifies the sign of the j-th luma coefficient of the filter indicated by sfIdx as follows:
If alf_luma_coeff_sign[sfIdx][j] is equal to 0, the corresponding luma filter coefficient has a positive value.
Otherwise (alf_luma_coeff_sign[sfIdx][j] is equal to 1), the corresponding luma filter coefficient has a negative value.

When alf_luma_coeff_sign[sfIdx][j] is not present, it is inferred to be equal to 0.

alf_luma_clip_idx[sfIdx][j] specifies the clipping index of the clipping value to use before multiplying by the j-th coefficient of the signalled luma filter indicated by sfIdx. When alf_luma_clip_idx[sfIdx][j] is not present, it is inferred to be equal to 0.

The coding tree unit syntax elements of ALF associated to LUMA component in VTM are listed as follows:

| | Descriptor |
|---|---|
| coding_tree_unit( ) { | |
| xCtb = CtbAddrX << CtbLog2SizeY | |
| yCtb = CtbAddrY << CtbLog2SizeY | |
| if( sh_alf_enabled_flag ){ | |
| alf_ctb_flag[ 0 ][ CtbAddrX ][ CtbAddrY ] | ae(v) |
| if( alf_ctb_flag[ 0 ][ CtbAddrX ][ CtbAddrY ] ) { | |
| if( sh_num_alf_aps_ids_luma > 0 ) | |
| alf_use_aps_flag | ae(v) |
| if( alf_use_aps_flag ) { | |
| if( sh_num_alf_aps_ids_luma > 1 ) | |
| alf_luma_prev_filter_idx | ae(v) |
| } else | |
| alf_luma_fixed_filter_idx | ae(v) |
| } | |
| } | |

alf_ctb_flag[cIdx][xCtb>CtbLog 2SizeY][yCtb>CtbLog 2SizeY] equal to 1 specifies that the adaptive loop filter is applied to the coding tree block of the colour component indicated by cIdx of the coding tree unit at luma location (xCtb, yCtb). alf_ctb_flag[cIdx][xCtb>CtbLog 2SizeY][yCtb>CtbLog 2SizeY] equal to 0 specifies that the adaptive loop filter is not applied to the coding tree block of the colour component indicated by cIdx of the coding tree unit at luma location (xCtb, yCtb).

When alf_ctb_flag[cIdx][xCtb>CtbLog 2SizeY][yCtb>CtbLog 2SizeY] is not present, it is inferred to be equal to 0.

alf_use_aps_flag equal to 0 specifies that one of the fixed filter sets is applied to the luma CTB.

alf_use_aps_flag equal to 1 specifies that a filter set from an APS is applied to the luma CTB. When alf_use_aps_flag is not present, it is inferred to be equal to 0.

alf_luma_prev_filter_idx specifies the previous filter that is applied to the luma CTB. The value of alf_luma_prev_filter_idx shall be in a range of 0 to sh_num_alf_aps_ids_luma−1, inclusive. When alf_luma_prev_filter_idx is not present, it is inferred to be equal to 0.

The variable AlfCtbFiltSetIdxY[xCtb>CtbLog 2SizeY][yCtb>CtbLog 2SizeY] specifying the filter set index for the luma CTB at location (xCtb, yCtb) is derived as follows:
If alf_use_aps_flag is equal to 0, AlfCtbFiltSetIdxY[xCtb>CtbLog 2SizeY][yCtb>CtbLog 2SizeY] is set equal to alf_luma_fixed_filter_idx.
Otherwise, AlfCtbFiltSetIdxY[xCtb CtbLog 2SizeY][yCtb CtbLog 2SizeY] is set equal to 16+alf_luma_prev_filter_idx.

aif_luma_fixed_filter_idx specifies the fixed filter that is applied to the luma CTB. The value of alf_luma_fixed_filter_idx shall be in a range of 0 to 15, inclusive.

Based on the ALF design of VTM, the ALF design of ECM further introduces the concept of alternative filter sets into luma filters. The luma filters are be trained multiple alternatives/rounds based on the updated luma CTU ALF on/off decisions of each alternative/rounds. In such way, there will be multiple filter sets that associated to each training alternative and the class merging results of each filter set may be different. Each CTU could select the best filter set by RDO and the related alternative information will be signaled.

The data syntax elements of ALF associated to LUMA component in ECM are listed as follows:

| | Descriptor |
|---|---|
| alf_data( ) { | |
| alf_luma_filter_signal_flag | u(1) |
| if( alf_luma_filter_signal_flag ) { | |
| alf_luma_num_alts_minus1 | ue(v) |
| for(altIdx = 0; altIdx < alf_luma_num_alts_minus1 +1; altIdx++){ | |
| alf_luma_clip_flag[altIdx] | u(1) |
| alf_luma_num_filters_signalled_minus1[altIdx] | ue(v) |
| if(alf_luma_num_filters_signalled_minus1[altIdx] > 0){ | |
| for( filtIdx = 0; filtIdx < NumAlfFilters; filtIdx++ ) | |
| alf_luma_coeff_delta_idx[altIdx][filtIdx] | u(v) |
| } | |
| for(sfIdx = 0; sfIdx <= alf_luma_num_filters_signalled_minus1[altIdx]; sfIdx++){ | |
| for(j = 0; j < 19; j++){ | |
| alf_luma_coeff_abs[altIdx][ sfIdx ][ j ] | ue(v) |
| if( alf_luma_coeff_abs[altIdx][ sfIdx ][ j ] ) | |
| alf_luma_coeff_sign[altIdx][ sfIdx ][ j ] | u(1) |
| } | |
| } | |
| if( alf_luma_clip_flag [altIdx]) | |
| for( sfIdx = 0; sfIdx <= alf_luma_num_filters_signalled_minus1[altIdx]; | |
| sfIdx++ ) | |
| for( j = 0; j <19; j++ ) | |
| alf_luma_clip_idx[altIdx][ sfIdx ][ j ] | u(2) |
| } | |
| } | |

alf_luma_num_alts_minus1 plus 1 specifies the number of alternative filter sets for luma component. The value of alf_luma_num_alts_minus1 shall be in the range of 0 to 3, inclusive.

alf_luma_clip_flag[altIdx] equal to 0 specifies that linear adaptive loop filtering is applied to the alternative luma filter set with index altIdx. alf_luma_clip_flag[altIdx] equal to 1 specifies that non-linear adaptive loop filtering could be applied to the alternative luma filter set with index altIdx.

alf_luma_num_filters_signalled_minus1[altIdx]plus 1 specifies the number of adaptive loop filter classes for which luma coefficients can be signalled of the alternative luma filter set with index altIdx. The value of alf_luma_num_filters_signalled_minus1[altIdx] shall be in the range of 0 to NumAlfFilters−1, inclusive.

alf_luma_coeff_delta_idx[altIdx][filtIdx] specifies the indices of the signalled adaptive loop filter luma coefficient deltas for the filter class indicated by filtIdx ranging from 0 to NumAlfFilters−1 for the alternative luma filter set with index altIdx. When alf_luma_coeff_delta_idx[filtIdx][altIdx] is not present, it is inferred to be equal to 0. The length of alf_luma_coeff_delta_idx[altIdx][filtIdx] is Ceil(Log 2(alf_luma_num_filters_signalled_minus1[altIdx]+1)) bits. The value of alf_luma_coeff_delta_idx[altIdx][filtIdx] shall be in the range of 0 to alf_luma_num_filters_signalled_minus1[altIdx], inclusive.

alf_luma_coeff_abs[altIdx][sfIdx][j] specifies the absolute value of the j-th coefficient of the signalled luma filter indicated by sfIdx of the alternative luma filter set with index altIdx. When alf_luma_coeff_abs[altIdx][sfIdx][j] is not present, it is inferred to be equal 0. The value of alf_luma_coeff_abs[altIdx][sfIdx][j] shall be in the range of 0 to 128, inclusive.

alf_luma_coeff_sign[altIdx][sfIdx][j] specifies the sign of the j-th luma coefficient of the filter indicated by sfIdx of the alternative luma filter set with index altIdx as follows:
If alf_luma_coeff_sign[altIdx][sfIdx][j] is equal to 0, the corresponding luma filter coefficient has a positive value.
Otherwise (alf_luma_coeff_sign[altIdx][sfIdx][j] is equal to 1), the corresponding luma filter coefficient has a negative value.

When alf_luma_coeff_sign[altIdx][sfIdx][j] is not present, it is inferred to be equal to 0.

alf_luma_clip_idx[altIdx][sfIdx][j] specifies the clipping index of the clipping value to use before multiplying by the j-th coefficient of the signalled luma filter indicated by sfIdx of the alternative luma filter set with index altIdx. When alf_luma_clip_idx[altIdx][sfIdx][j] is not present, it is inferred to be equal to 0.

The coding tree unit syntax elements of ALF associated to LUMA component in ECM are listed as follows:

| | Descriptor |
|---|---|
| coding_tree_unit( ) { | |
| xCtb = CtbAddrX << CtbLog2SizeY | |
| yCtb = CtbAddrY << CtbLog2SizeY | |
| if( sh_alf_enabled_flag ){ | |
| alf_ctb_flag[ 0 ][ CtbAddrX ][ CtbAddrY ] | ae(v) |
| if( alf_ctb_flag[ 0 ][ CtbAddrX ][ CtbAddrY ] ) { | |
| if( sh_num_alf_aps_ids_luma > 0 ) | |
| alf_use_aps_flag | ae(v) |
| if( alf_use_aps_flag ) { | |
| if( sh_num_alf_aps_ids_luma > 1 ) | |
| alt_ctb_luma_filter_alt_idx[CtbAddrX][CtbAddrY] | ae(v) |
| alf_luma_prev_filter_idx | ae(v) |
| } else | |
| alf_luma_fixed_filter_idx | ae(v) |
| } | |
| } | |

alf_ctb_luma_filter_alt_idx[xCtb>>CtbLog 2SizeY][yCtb>>CtbLog 2SizeY] specifies the index of the alternative luma filters applied to the coding tree block of the luma component, of the coding tree unit at luma location (xCtb, yCtb). When alf_ctb_luma_filter_alt_idx[xCtb>>CtbLog 2SizeY][yCtb>>CtbLog 2SizeY] is not present, it is inferred to be equal to zero.

### 3.8.2. Filter Shapes

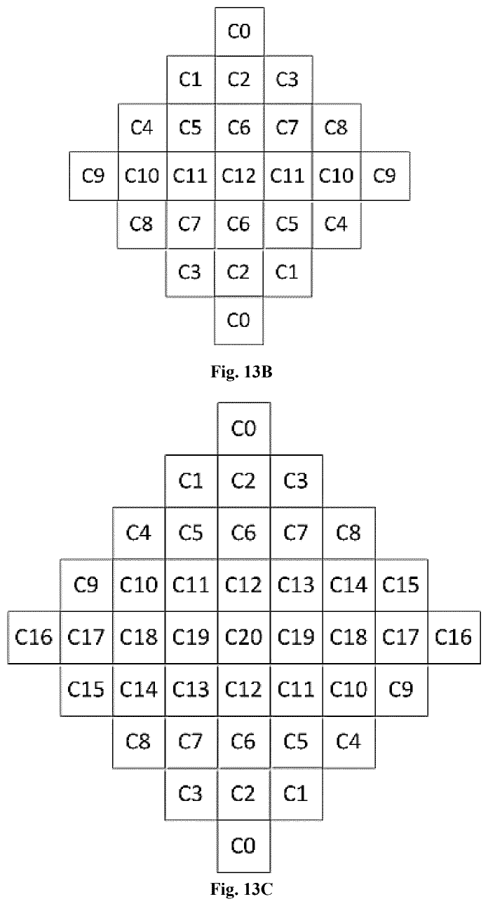

FIG. 13A-FIG. 13C illustrate filter shapes for ALF, respectively. In the JEM, up to three diamond filter shapes (as shown in FIG. 13A-FIG. 13C) can be selected for the luma component. An index is signalled at the picture level to indicate the filter shape used for the luma component. Each square represents a sample, and Ci (i being 0˜6 (left), 0˜12 (middle), 0˜20 (right)) denotes the coefficient to be applied to the sample. For chroma components in a picture, the 5×5 diamond shape is always used. In VVC, the 7×7 diamond shape is always used for Luma while the 5×5 diamond shape is always used for Chroma.

### 3.8.3. Classification for ALF

Each 2×2 (or 4×4) block is categorized into one out of 25 classes. The classification index C is derived based on its directionality D and a quantized value of activity Â, as follows:

$$C = 5 D + \hat{A} .$$

To calculate D and Â, gradients of the horizontal, vertical and two diagonal direction are first calculated using 1-D Laplacian:

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert ,$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert ,$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert$$

$${g}_{d 2} = {\sum }_{k = i - 2}^{i + 3} {\sum }_{j = j - 2}^{j + 3} D {2}_{k , l} , D {2}_{k , l} = \vert 2 R ( k , l ) - R ( k - 1 , l + 1 ) - R ( k + 1 , l - 1 ) \vert$$

Indices i and j refer to the coordinates of the upper left sample in the 2×2 block and R(i,j) indicates a reconstructed sample at coordinate (i,j).

Then D maximum and minimum values of the gradients of horizontal and vertical directions are set as:

$${g}_{h , v}^{max} = max ( {g}_{h} , {g}_{v} ) , {g}_{h , v}^{min} = min ( {g}_{h} , {g}_{v} ) ,$$

and the maximum and minimum values of the gradient of two diagonal directions are set as:

$${g}_{d 0 , d 1}^{max} = max ( {g}_{d 0} , {g}_{d 1} ) , {g}_{d 0 , d 1}^{min} = min ( {g}_{d 0} , {g}_{d 1} ) ,$$

To derive the value of the directionality D, these values are compared against each other and with two thresholds t₁ and t₂:

$$If both {g}_{h , v}^{max} \leq {t}_{1} \cdot {g}_{h , v}^{min} and {g}_{d 0 , d 1}^{max} \leq {t}_{1} \cdot {g}_{d 0 , d 1}^{min} are true , \\ D is set to 0. \qquad Step 1.$$

$$If {g}_{h , v}^{max} / {g}_{h , v}^{min} > {g}_{d 0 , d 1}^{max} / {g}_{d 0 , d 1}^{min} , continue from Step 3 ; \\ otherwise continue from Step 4. \qquad Step 2.$$

$$If {g}_{h , v}^{max} > {t}_{2} \cdot {g}_{h , v}^{min} , D is set to 2 ; otherwise D is set to 1. \qquad Step 3.$$

$$If {g}_{d 0 , d 1}^{max} > {t}_{2} \cdot {g}_{d 0 , d 1}^{min} , D is set to 4 ; otherwise D is set to 3. \qquad Step 4.$$

The activity value A is calculated as:

$$A = {\sum }_{k = i - 2}^{i + 3} {\sum }_{l = j - 2}^{j + 3} ( {V}_{k , l} + {H}_{k , l} ) .$$

A is further quantized to the range of 0 to 4, inclusively, and the quantized value is denoted as Â.

For both chroma components in a picture, no classification method is applied, i.e. a single set of ALF coefficients is applied for each chroma component.

### 3.8.4. Geometric Transformations of Filter Coefficients

Before filtering each 2×2 block, geometric transformations such as rotation or diagonal and vertical flipping are applied to the filter coefficients f(k,l), which is associated with the coordinate (k,l), depending on gradient values calculated for that block. This is equivalent to applying these transformations to the samples in the filter support region. The idea is to make different blocks to which ALF is applied more similar by aligning their directionality.

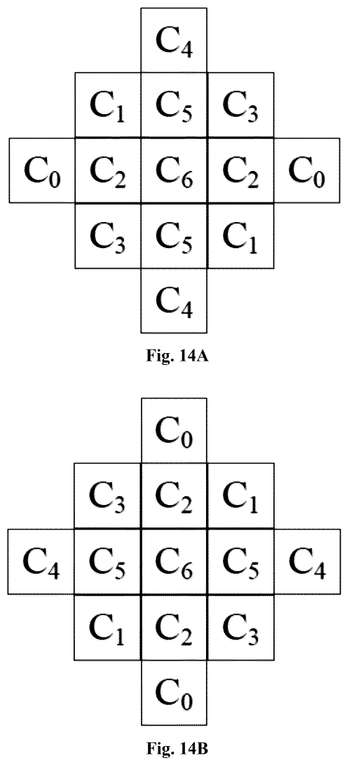

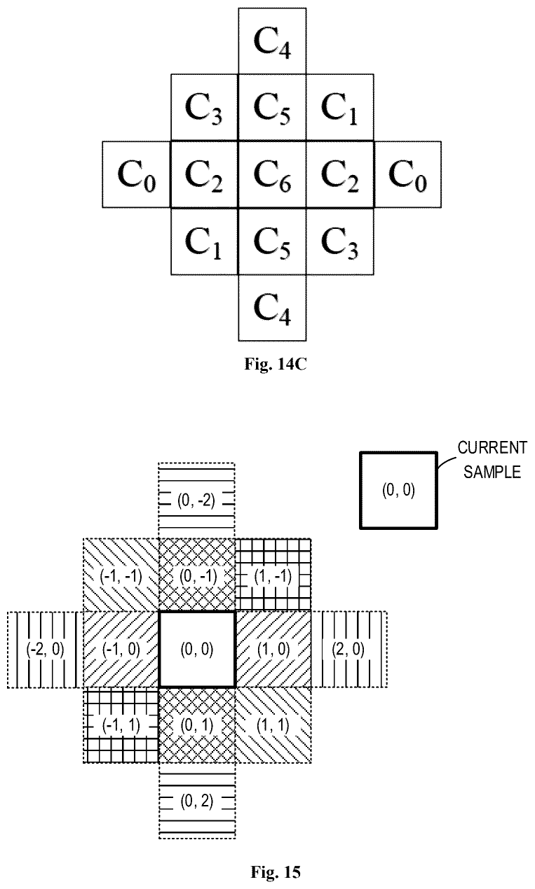

Three geometric transformations, including diagonal, vertical flip and rotation are introduced:

$$Diagonal : {f}_{D} ( k , l ) = f ( l , k ) ,$$

$$Vertical flip : {f}_{V} ( k , l ) = f ( k , K - l - 1 ) ,$$

$$Rotation : {f}_{R} ( k , l ) = f ( K - l - 1 , k ) .$$

where K is the size of the filter and 0≤k, l≤K−1 are coefficients coordinates, such that location (0,0) is at the upper left corner and location (K−1, K−1) is at the lower right corner. The transformations are applied to the filter coefficients f(k,l) depending on gradient values calculated for that block. The relationship between the transformation and the four gradients of the four directions are summarized in Table 3-5. FIG. 14A-FIG. 14C illustrate relative coordinator for the 5×5 diamond filter support, respectively. FIG. 14A-FIG. 14C show the transformed coefficients for each position based on the 5×5 diamond.

TABLE 3-5
Mapping of the gradient calculated for
one block and the transformations.

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

### 3.8.5. Filtering Process

At decoder side, when ALF is enabled for a block, each sample R(i,j) within the block is filtered, resulting in sample value R′(i,j) as shown below, where L denotes filter length, f_{m,n} represents filter coefficient, and f(k,l) denotes the decoded filter coefficients.

$${R}^{′} ( i , j ) = {\sum }_{k = - L / 2}^{L / 2} {\sum }_{l = - L / 2}^{L / 2} f ( k , l ) \times R ( i + k , j + l ) .$$

FIG. 15 illustrates examples of relative coordinates for the 5×5 diamond filter support. FIG. 15 shows an example of relative coordinates used for 5×5 diamond filter support supposing the current sample's coordinate (i,j) to be (0, 0). Samples in different coordinates filled with the same color are multiplied with the same filter coefficients.

3.8.6. Non-Linear Filtering Reformulation Linear filtering can be reformulated, without coding efficiency impact, in the following expression:

$$O ( x , y ) = I ( x , y ) + {\sum }_{( i , j ) \neq ( 0 , 0 )} w ( i , j ) \cdot ( I ( x + i , y + j ) - I ( x , y ) )$$

where w(i,j) are the same filter coefficients.

VVC introduces the non-linearity to make ALF more efficient by using a simple clipping function to reduce the impact of neighbor sample values (I(x+i,y+j)) when they are too different with the current sample value (I(x,y)) being filtered.

More specifically, the ALF filter is modified as follows:

$${O}^{′} ( x , y ) = I ( x , y ) + {\sum }_{( i , j ) \neq ( 0 , 0 )} w ( i , j ) \cdot K ( I ( x + i , y + j ) - I ( x , y ) , k ( i , j ) )$$

where K(d,b)=min(b,max(−b,d)) is the clipping function, and k(i,j) are clipping parameters, which depends on the (i,j) filter coefficient. The encoder performs the optimization to find the best k(i,j).

The clipping parameters k(i,j) are specified for each ALF filter, one clipping value is signaled per filter coefficient. It means that up to 12 clipping values can be signalled in the bitstream per Luma filter and up to 6 clipping values for the Chroma filter.

In order to limit the signaling cost and the encoder complexity, only 4 fixed values which are the same for INTER and INTRA slices are used.

Because the variance of the local differences is often higher for Luma than for Chroma, two different sets for the Luma and Chroma filters are applied. The maximum sample value (here 1024 for 10 bits bit-depth) in each set is also introduced, so that clipping can be disabled if it is not necessary.

The 4 values have been selected by roughly equally splitting, in the logarithmic domain, the full range of the sample values (coded on 10 bits) for Luma, and the range from 4 to 1024 for Chroma.

More precisely, the Luma table of clipping values have been obtained by the following formula:

$${AlfClip}_{L} = \{ round ( {( {( M )}^{\frac{1}{N}} )}^{N - n + 1} ) for n ∈ 1 .. N ] \} , \\ with M = {2}^{10} and N = 4.$$

Similarly, the Chroma tables of clipping values is obtained according to the following formula:

$${AlfClip}_{C} = \{ round ( A \cdot {( {( \frac{M}{A} )}^{\frac{1}{N - 1}} )}^{N - n} ) for n ∈ 1 .. N ] \} , \\ with M = {2}^{10} , N = 4 and A = 4.$$

3.9. Bilateral in-Loop Filter

### 3.9.1. Bilateral Image Filter

Bilateral image filter is a nonlinear filter that smooths the noise while preserving edge structures. The bilateral filtering is a technique to make the filter weights decrease not only with the distance between the samples but also with increasing difference in intensity. This way, over-smoothing of edges can be ameliorated. A weight is defined as

$$w ( Δ x , Δ y , Δ I ) = {e}^{- \frac{Δ {x}^{2} + Δ {y}^{2}}{2 {σ}_{d}^{2}} - \frac{Δ {I}^{2}}{2 {σ}_{r}^{2}}}$$

where Δx and Δy is the distance in the vertical and horizontal and ΔI is the difference in intensity between the samples.

The edge-preserving de-noising bilateral filter adopts a low-pass Gaussian filter for both the domain filter and the range filter. The domain low-pass Gaussian filter gives higher weight to pixels that are spatially close to the center pixel. The range low-pass Gaussian filter gives higher weight to pixels that are similar to the center pixel. Combining the range filter and the domain filter, a bilateral filter at an edge pixel becomes an elongated Gaussian filter that is oriented along the edge and is greatly reduced in gradient direction. This is the reason why the bilateral filter can smooth the noise while preserving edge structures.

### 3.9.2. Bilateral Filter in Video Coding

The bilateral filter in video coding is proposed as a coding tool for the VVC. The filter acts as a loop filter in parallel with the sample adaptive offset (SAO) filter. Both the bilateral filter and SAO act on the same input samples, each filter produces an offset, and these offsets are then added to the input sample to produce an output sample that, after clipping, goes to the next stage. The spatial filtering strength σ_{d} is determined by the block size, with smaller blocks filtered more strongly, and the intensity filtering strength σᵣ is determined by the quantization parameter, with stronger filtering being used for higher QPs. Only the four closest samples are used, so the filtered sample intensity I_{F} can be calculated as

$${I}_{F} = {I}_{C} + \frac{{w}_{A} Δ {I}_{A} + {w}_{B} Δ {I}_{B} + {w}_{L} Δ {I}_{L} + {w}_{R} Δ {I}_{R}}{{w}_{C} + {w}_{A} + {w}_{B} + {w}_{L} + {w}_{R}}$$

where I_{C} denotes the intensity of the center sample, ΔI_{A}=I_{A}−I_{C} the intensity difference between the center sample and the sample above. ΔI_{B}, ΔI_{L} and ΔI_{R} denote the intensity difference between the center sample and that of the sample below, to the left and to the right respectively.

### 4. Cross-Component Residual Model

The cross-component residual model (CCRM) is proposed to predict chroma samples from reconstructed luma samples when the block used inter prediction or intra block copy (IBC). The cross-component models are derived using the prediction signals of luma and chroma. The derived models are applied to the reconstructed luma signal producing the final chroma predictions. The CCRM consists of spatial luma samples, nonlinear term, and bias term. The spatial luma samples are obtained from the neighbour luma samples that closest to the chroma position.

The model parameters are derived using Gaussian elimination method and the necessary offsets are applied to samples prior to model derivation.

Intra reference samples may be used as additional input samples in model derivation when the block has less than N chroma samples.

Usage of the CCRM mode is signalled with a TU level flag. The CCRM flag is only signalled if the TU's luma CBF is non-zero and the CU's prediction mode is either MODE_INTER or MODE_IBC.

5. IntraTMP Based on Linear Filter Model The proposed 6-tap filter consist of a 5-tap plus sign shape spatial component and a bias term. The input to the spatial 5-tap component of the filter consists of a center (C) sample in the reference block which is at corresponding locations with the sample in the current block to be predicted and its above/north (N), below/south (S), left/west (W) and right/east (E) neighbors as illustrated below.

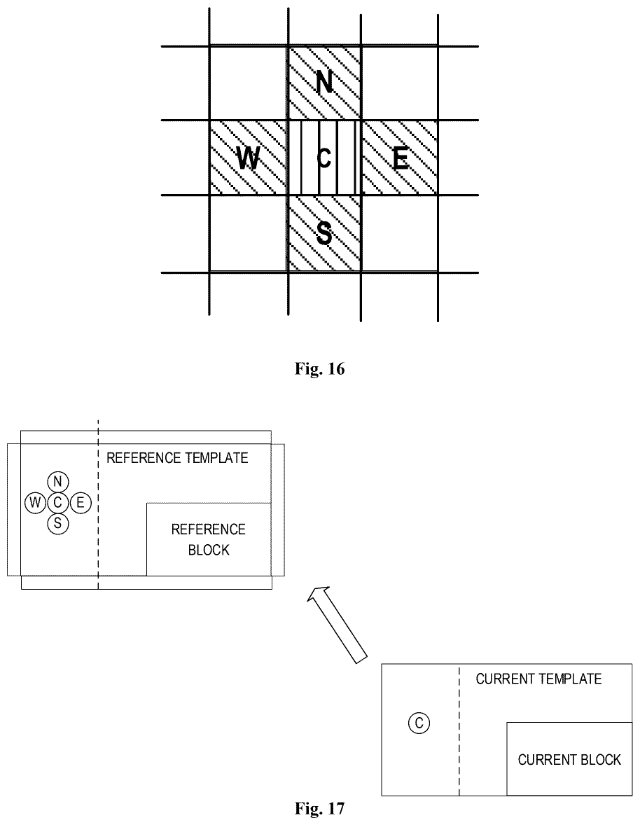

FIG. 16 illustrates spatial part of the filter.

The bias term B represents a scalar offset between the input and output and is set to middle luma value (512 for 10-bit content).

Output of the filter is calculated as follows:

$$predLumaVal = c 0 C + c 1 N + c 2 S + c 3 E + c 4 W + c 5 B .$$

The filter coefficients ci are calculated by minimising the MSE between the reference template and current template. The extensions to the area shown in blue area needed to support the “side samples” of the plus shaped spatial filter and are padded when in unavailable areas.

FIG. 17 illustrates reference area used to derive the filter coefficients.

The MSE minimization is performed by calculating autocorrelation matrix for the reference template input and current template output. Autocorrelation matrix is LDL decomposed and the final filter coefficients are calculated using back-substitution.

Usage of the Intra TMP-FLM mode is signalled coded CU level flag. Specifically, Intra TMP-FLM is considered a sub-mode of Intra TMP. That is, Intra TMP-FLM flag is only signalled if Intra TMP flag is true.

### 6. Filtered Intra Block Copy (FIBC)

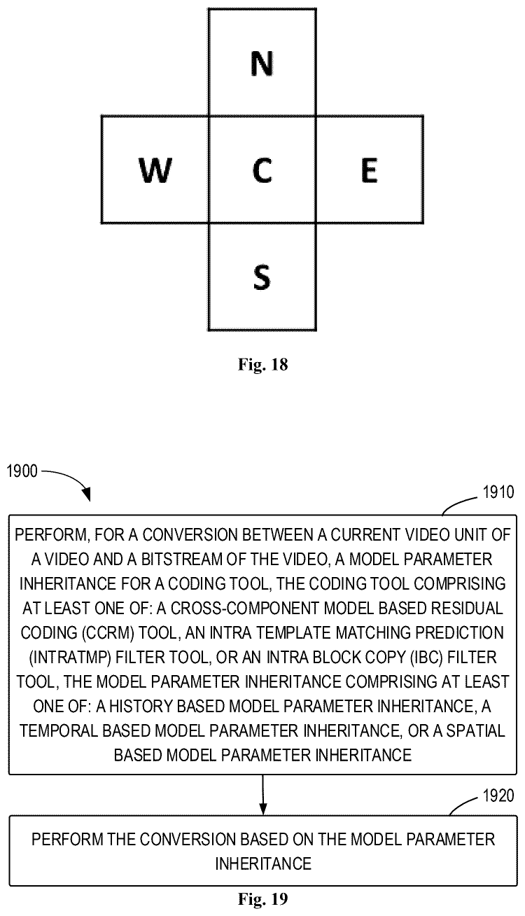

FIG. 18 illustrates an example of filter shape.

Filtered IBC (FIBC) is proposed which applies one linear filter to the prediction samples of the IBC. The filter consists of five spatial terms and a bias term. The five spatial terms consist of a center (C) position and its above/north (N), below/south (S), left/west (W) and right/east (E) neighbors.

$$predVal = {α}_{0} \cdot C + {α}_{1} \cdot N + {α}_{2} \cdot S + {α}_{3} \cdot W + {α}_{4} \cdot E + {α}_{5} \cdot β$$

where αⱼ is the coefficient and β is the offset. Up to 4 lines/columns of samples above and left to the current CU are applied to derive the filter coefficients. The filter coefficients are derived based on the minimization of the difference between the template samples and their corresponding reference samples via the same regression-based minimization technique in the ECM that is used by other tools such as CCCM.

For the signaling, one extra indication flag is introduced for the FIBC which is signaled after the IBC-LIC flag. Specifically, when the IBC-LIC flag is true, the flag is signaled and used to indicate whether the FIBC is applied to the current block or not.

### 7. Problems

The existing designs for model derivation based tool for video coding have the following problems:
1. In current model derivation based tool (e.g., CCRM), the derived parameters are only applied to a specific block. However, the parameters derived from previous coded blocks can be further inherited for current coding block to further enhance the coding efficiency.
2. The filter models for intraTMP and IBC are not stored and used for filtering a future block, which may be suboptimal.

### 8. Detailed Solutions

To solve the above problems and some other problems not mentioned, methods as summarized below are disclosed. The embodiments should be considered as examples to explain the general concepts and should not be interpreted in a narrow way. Furthermore, these embodiments can be applied individually or combined in any manner.

In this disclosure, a video unit may refer to a sequence, a picture, a sub-picture, a slice, a CTU, a TU, a block, or a region. The video unit may comprise one color component or it may comprise multiple color components.

In this disclosure, model derivation based tool may refer to cross-component linear model (CCLM), cross-component convolutional model (CCCM), cross-component residual model (CCRM), multi-model linear model (MMLM), gradient linear model (GLM), chroma fusion or any other online-training based methods.

The term “CCRM” may refer to a cross-component model based residual derivation. It may also infer to a CCCM model based inter/IBC coding (such as inter/IBC CCCM). It may also infer to a CCCM model based intra coding (such as intra CCCM).
1) It is proposed to perform history/temporal/spatial based model parameter inheritance for model derivation based tools (e.g., CCRM/intraTMP filter/IBC filter, etc.).
   a. In one example, the model parameter set derived by a temporally previous CCRM/intraTMP/IBC coded video unit may be stored at both encoder and decoder.
      i. In one example, the model parameter set derived by a temporally previous CCRM/intraTMP/IBC coded video unit inside current CTU/CTU row may be stored.
      ii. In one example, the model parameter set derived by a temporally previous CCRM/intraTMP/IBC coded video unit inside current slice/tile/picture may be stored.
      iii. In one example, the model parameter set derived by a temporally previous CCRM/intraTMP/IBC coded video unit inside previous coded/co-located CTU/CTU row may be stored.
      iv. In one example, the model parameter set derived by a temporally previous CCRM/intraTMP/IBC coded video unit inside previous coded slice/tile/picture may be stored.
   b. In one example, a history/temporal/spatial model parameter set may be reused by current video unit.
      i. In one example, all the coefficients inside the model parameter set may be reused.
      ii. In one example, one or more coefficients inside the model parameter set may be reused.
         a) In one example, only the coefficients correspond to spatial taps may be reused.
         b) In one example, only the coefficients correspond to the nonlinear taps may be reused.
         c) In one example, only the coefficients correspond to the bias taps may be reused.
      iii. In one example, the filter model (e.g., filter shape, filter taps, filter terms, offsets, etc.) may be stored and reused.
      iv. In one example, whether and how a multi-model is applied (e.g., yThres, etc.) may be stored and reused.
      v. In one example, whether and how a multi-filter is applied (e.g., model index of MDF, etc.) may be stored and reused.
   c. In one example, the reference sample from a history/temporal CCRM/intraTMP/IBC coded video unit may be reused by current video unit.
   d. In one example, the reference area/template (e.g., top/left) from a history/temporal CCRM/intraTMP/IBC coded video unit may be used by current video unit.
   e. In one example, one history/temporal/spatial model parameter set list may be maintained during encoding and decoding process.
      i. In one example, the list may contain all history/temporal model parameter sets during coding progress.
      ii. In one example, the list may only contain history/temporal model parameter set that inside current CTU/CTU row.
      iii. In one example, the list may only contain history/temporal model parameter set that inside current slice/tile/picture.
      iv. In one example, the list may contain up to N (e.g., N=12) candidates.
      v. In one example, the list may be updated following the first in first out (FIFO) rule.
      vi. In one example, the list may be updated following other rules.
      vii. In one example, the list may be updated with pruning.
         a) In one example, checking may be performed to find whether the newly added candidate is identical with a candidate inside the list.
         b) In one example, when newly added candidate is identical with a candidate inside the list, the old candidate may be removed.
      viii. In one example, the list may be updated without pruning.
      ix. In one example, the list may be reset for each CTU/CTU row.
      x. In one example, the list may be reset for each slice/tile/picture.
      xi. In one example, a candidate index may be signalled/derived/pre-defined to indicate which candidate is selected.
   f. In one example, the model parameter set of a CCRM/intraTMP filter/IBC filter coded video unit may be stored and used for filtering a subsequent CCRM/intraTMP/IBC coded video unit in the current picture.
      i. For example, it may be stored in a history-based look-up-table.
      ii. For example, the maximum size of the history table may be pre-defined (such as K elements, K=6 or 10 or 12).
      iii. For example, the element inserted into the history table may follow a first-in-first-out (FIFO) order.
   g. In one example, the model parameter set of a CCRM/intraTMP filter/IBC filter coded video unit may be stored and used for filtering a future CCRM/intraTMP/IBC coded video unit in a subsequent picture.
      i. For example, the model parameter sets may be stored in a temporal buffer.
      ii. For example, the model parameter sets may be treated as a temporal buffer associated with a reference picture.
2) It is proposed to perform spatial adjacent based model parameter inheritance for model derivation based tools (e.g., CCRM/intraTMP filter/IBC filter, etc).
   a. In one example, the model parameter set derived by a spatial adjacent previous CCRM/intraTMP/IBC coded video unit may be stored at both encoder and decoder.
      i. In one example, the model parameter set derived by a spatial adjacent previous CCRM/intraTMP/IBC coded video unit inside current CTU/CTU row may be stored.
      ii. In one example, the model parameter set derived by a spatial adjacent previous CCRM/intraTMP/IBC coded video unit inside current slice/tile/picture may be stored.
      iii. In one example, the model parameter set derived by a spatial adjacent previous CCRM/intraTMP/IBC coded video unit inside previous coded/co-located CTU/CTU row may be stored.
      iv. In one example, the model parameter set derived by a spatial adjacent previous CCRM/intraTMP/IBC coded video unit inside previous coded slice/tile/picture may be stored.
   b. In one example, a spatial adjacent model parameter set may be reused by current video unit.
      i. In one example, all the coefficients inside the model parameter set may be reused.
      ii. In one example, one or more coefficients inside the model parameter set may be reused.
         a) In one example, only the coefficients correspond to spatial taps may be reused.
         b) In one example, only the coefficients correspond to the nonlinear taps may be reused.
         c) In one example, only the coefficients correspond to the bias taps may be reused.
      iii. In one example, the filter model (e.g., filter shape, filter taps, filter terms, offsets, etc.) may be stored and reused.
      iv. In one example, whether and how a multi-model is applied (e.g., yThres, etc.) may be stored and reused.
      v. In one example, whether and how a multi-filter is applied (e.g., model index of MDF, etc.) may be stored and reused.
   c. In one example, the reference sample from a spatial adjacent CCRM/intraTMP/IBC coded video unit may be reused by current video unit.
   d. In one example, the reference area/template (e.g., top/left) from a spatial adjacent CCRM/intraTMP/IBC coded video unit may be used by current video unit.
   e. In one example, one spatial adjacent model parameter set list may be maintained during encoding and decoding process.
      i. In one example, the list may contain all spatial adjacent model parameter sets for current vide unit.
      ii. In one example, the list may only contain spatial adjacent model parameter set that inside current CTU/CTU row.
      iii. In one example, the list may only contain spatial adjacent model parameter set that inside current slice/tile/picture.
      iv. In one example, the list may contain up to N (e.g., N=6) candidates.
      v. In one example, the list may be updated following the first in first out (FIFO) rule.
      vi. In one example, the list may be updated following other rules.
      vii. In one example, the list may be updated with pruning.
         a) In one example, checking may be performed to find whether the newly added candidate is identical with a candidate inside the list.
         b) In one example, when newly added candidate is identical with a candidate inside the list, the old candidate may be removed.
      viii. In one example, the list may be updated without pruning.
      ix. In one example, the list may be reset for each video unit.
      x. In one example, a candidate index may be signalled/derived/pre-defined to indicate which candidate is selected.
3) It is proposed to perform spatial non-adjacent based model parameter inheritance for model derivation based tools (e.g., CCRM/intraTMP filter/IBC filter, etc).
   a. In one example, the model parameter set derived by a spatial non-adjacent previous CCRM/intraTMP/IBC coded video unit may be stored at both encoder and decoder.
      i. In one example, the model parameter set derived by a spatial non-adjacent previous CCRM/intraTMP/IBC coded video unit inside current CTU/CTU row may be stored.
      ii. In one example, the model parameter set derived by a spatial non-adjacent previous CCRM/intraTMP/IBC coded video unit inside current slice/tile/picture may be stored.
      iii. In one example, the model parameter set derived by a spatial non-adjacent previous CCRM/intraTMP/IBC coded video unit inside previous coded/co-located CTU/CTU row may be stored.
      iv. In one example, the model parameter set derived by a spatial non-adjacent previous CCRM/intraTMP/IBC coded video unit inside previous coded slice/tile/picture may be stored.
   b. In one example, a spatial non-adjacent model parameter set may be reused by current video unit.
      i. In one example, all the coefficients inside the model parameter set may be reused.
      ii. In one example, one or more coefficients inside the model parameter set may be reused.
         a) In one example, only the coefficients correspond to spatial taps may be reused.
         b) In one example, only the coefficients correspond to the nonlinear taps may be reused.
         c) In one example, only the coefficients correspond to the bias taps may be reused.
      iii. In one example, the filter model (e.g., filter shape, filter taps, filter terms, offsets, etc.) may be stored and reused.
      iv. In one example, whether and how a multi-model is applied (e.g., yThres, etc.) may be stored and reused.
      v. In one example, whether and how a multi-filter is applied (e.g., model index of MDF, etc.) may be stored and reused.
   c. In one example, the reference sample from a spatial non-adjacent CCRM/intraTMP/IBC coded video unit may be reused by current video unit.
   d. In one example, the reference area/template (e.g., top/left) from a spatial non-adjacent CCRM/intraTMP/IBC coded video unit may be used by current video unit.
   e. In one example, one spatial non-adjacent model parameter set list may be maintained during encoding and decoding process.
      i. In one example, the list may contain all spatial non-adjacent model parameter sets for current vide unit.
      ii. In one example, the list may only contain spatial non-adjacent model parameter set that inside current CTU/CTU row.
      iii. In one example, the list may only contain spatial non-adjacent model parameter set that inside current slice/tile/picture.
      iv. In one example, the list may contain up to N (e.g., N=6) candidates.
      v. In one example, the list may be updated following the first in first out (FIFO) rule.
      vi. In one example, the list may be updated following other rules.
      vii. In one example, the list may be updated with pruning.
         a) In one example, checking may be performed to find whether the newly added candidate is identical with a candidate inside the list.
         b) In one example, when newly added candidate is identical with a candidate inside the list, the old candidate may be removed.
      viii. In one example, the list may be updated without pruning.
      ix. In one example, the list may be reset for each video unit.
      x. In one example, the list may be reset for each CTU/CTU row.
      xi. In one example, the list may be reset for each slice/tile/picture.
      xii. In one example, a candidate index may be signalled/derived/pre-defined to indicate which candidate is selected.
4) In one example, spatial parameters may be inherited from an adjacent or non-adjacent neighbouring block.
   a. In one example, the adjacent neighbouring block may be a block which is used to inherit motion information in merge mode.
   b. In one example, the non-adjacent neighbouring block may be a block which is used to inherit motion information in merge mode.
   c. In one example, the position of the adjacent or non-adjacent neighbouring block may depend on the position and/or width and/or height of the current block.
5) It is proposed to perform pre-defined/defaulted based model parameter set inheritance for model derivation based tools (e.g., CCRM/intraTMP filter/IBC filter, etc).
   a. In one example, one or more pre-defined model parameter sets may be stored at both encoder and decoder.
   b. In one example, a pre-defined model parameter set may be used for current video unit.
   c. In one example, a candidate index may be signalled/derived/pre-defined to indicate which pre-defined model parameter set is selected.
6) In one example, a model candidates list may be generated for the CCRM/intraTMP/IBC model parameter inheritance mode for the current video unit coding.
   a. In one example, the spatial candidates may be inserted prior to other types (e.g., history-based, temporal based, etc.) of candidates.
   b. In one example, it may follow the order of “spatial adjacent, spatial non-adjacent, history-based, temporal, default candidates” for model parameter candidate list filling.
   c. In one example, the checking order of spatial adjacent model candidates may be same as the spatial adjacent merge candidates for the merge list derivation.
   d. In one example, the checking order of spatial non-adjacent model candidates may be same as the spatial adjacent merge candidates for the merge list derivation.
   e. In one example, the checking order of temporal model candidates may be same as the temporal merge candidates for the merge list derivation.
      i. Moreover, for example, a set of shifted temporal model candidate may be inserted, wherein the shift factor may be derived based on a motion/block vector of a neighbor block.
   f. In one example, template cost based reordering process may be applied for the model candidates list generation.
      i. For example, a template cost may be calculated for each potential candidate to be put into the list by minimizing the SAD between the model predicted samples and reconstructed samples in a training region.
      ii. For example, the order of potential candidates to be put in the list may be reordered based on template cost in ascending order.
   g. In one example, template cost based reordering process may be applied on the model candidates list after the list has been constructed.
      i. For example, a template cost may be calculated for each candidate in the list by minimizing the SAD between the model predicted samples and reconstructed samples in a training region.
      ii. For example, the order of candidates in the list may be reordered based on template cost in ascending order.
7) In one example, a first syntax element (SE) may be signaled to indicate whether the inheritance mode is applied or not.
   a. For example, the SE may be a flag.
   b. For example, the SE may be coded with at least one context model.
   c. For example, the SE may be bypass coded.
   d. For example, the SE is coded only if the current block is coded with a specific mode, such as CCRM.
8) In one example, a second syntax element (SE) may be signaled to indicate which candidate in the candidate list is used.
   a. For example, the SE may be binarized as a truncated-unary code/or fixed length code/or exponential Golomb code.
   b. For example, a bin of the SE may be coded with at least one context model.
   c. For example, a bin of the SE may be bypass coded.
   d. The second SE is signaled only if the first SE indicates that inheritance mode is applied.
9) In one example, both intraTMP filter parameters and IBC filter parameters may be allowed to be inherited to generate a luma prediction for current non-intra video unit (e.g., IBC and/or intraTMP).
   a. Alternatively, for example, intraTMP filter parameters may be allowed to be inherited to generate a luma prediction for a current intraTMP video unit.
   b. Alternatively, for example, IBC filter parameters may be allowed to be inherited to generate a luma prediction for a current IBC video unit.
10) In one example, CCRM filter parameters may be allowed to be inherited to generate a chroma prediction for current non-intra video unit (e.g., inter and/or IBC).
11) A default candidate may be with fixed or predefined parameters and/or other associated information.
   a. Alternatively, a default candidate may be with parameters and/or other associated information derived from existing candidates in the list.
12) In one example, the methods disclosed may be applied on multiple color components (such as Cb and Cr) together.
   a. For example, multiple color components may share the same candidate list.
   b. For example, multiple color components may share the same syntax elements (e.g. the first and second SEs).
   c. For example, the SADs of templates of multiple color components may be summed to get a unique template cost.
13) In one example, the methods disclosed may be applied on multiple color components (such as Cb and Cr) separately.
   a. For example, multiple color components may have different candidate lists.
   b. For example, multiple color components may have different same syntax elements (e.g. the first and second SEs).
   c. For example, the SADs of templates of multiple color components may be considered separately.
14) In one example, the disclosed methods may be used in post-processing and/or pre-processing.
15) In one example, the above-mentioned methods may be used jointly.
   a. In one example, the different category of model parameter set may be jointly inserted into one inheritance list.
      i. In one example, the list may contain up to N (e.g., N=12) candidates.
      ii. In one example, the list may be updated following the first in first out rule.
      iii. In one example, the list may be updated following any other rules.
      iv. In one example, the list may be updated with pruning.
         a) In one example, checking may be performed to find whether the newly added candidate is identical with a candidate inside the list.
         b) In one example, when newly added candidate is identical with a candidate inside the list, the old candidate may be removed.
      v. In one example, the list may be updated without pruning.
      vi. In one example, the list may be reset for each CTU/CTU row.
      vii. In one example, the list may be reset for each slice/tile/picture.
   b. In one example, the model parameter set may be reused/inherited from the inheritance list.
   c. In one example, a candidate index may be signaled/derived/pre-defined to indicate which model parameter set is selected.
16) Alternatively, the above-mentioned methods may be used individually.
17) In one example, the proposed/described model parameter inheritance method may be applied to any in-loop filtering tools, prediction tools, pre-processing, or post-processing filtering method in video coding.
18) In above examples, the video unit may refer to sequence/picture/sub-picture/slice/tile/coding tree unit (CTU)/CTU row/groups of CTU/coding unit (CU)/prediction unit (PU)/transform unit (TU)/coding tree block (CTB)/coding block (CB)/prediction block (PB)/transform block (TB)/any other region that contains more than one luma or chroma sample/pixel.
19) Whether to and/or how to apply the disclosed methods above may be signalled in a bitstream.
   a. In one example, they may be signalled at sequence level/group of pictures level/picture level/slice level/tile group level, such as in sequence header/picture header/SPS/VPS/DPS/DCI/PPS/APS/slice header/tile group header.
   b. In one example, they may be signalled at PB/TB/CB/PU/TU/CU/VPDU/CTU/CTU row/slice/tile/sub-picture/other kinds of region contain more than one sample or pixel.
20) Whether to and/or how to apply the disclosed methods above may be dependent on coded information, such as block size, colour format, single/dual tree partitioning, colour component, slice/picture type.

FIG. 19 illustrates a flowchart of a method 1900 for video processing in accordance with embodiments of the present disclosure. The method 1900 is implemented during a conversion between a video unit of a video and a bitstream of the video.

At block 1910, for a conversion between a current video unit of a video and a bitstream of the video, a model parameter inheritance for a coding tool is performed. The coding tool comprises at least one of: a cross-component model based residual coding (CCRM) tool, an intra template matching prediction (intraTMP) filter tool, or an intra block copy (IBC) filter tool. The model parameter inheritance comprises at least one of: a history based model parameter inheritance, a temporal based model parameter inheritance, or a spatial based model parameter inheritance. In other words, history/temporal/spatial based model parameter inheritance is performed for model derivation based tools (e.g., CCRM/intraTMP filter/IBC filter, etc.).

At block 1920, performing the conversion based on the model parameter inheritance.

The method 1900 enables the model parameter inheritance, and thus improves the coding efficiency and/or coding effectiveness.

In some embodiments, a model parameter set derived by a temporally previous coded video unit is stored at an encoder and a decoder for the conversion, the temporally previous coded video unit comprising at least one of: a temporally previous CCRM coded video unit, a temporally previous intraTMP coded video unit, or a temporally previous IBC coded video unit.

In some embodiments, the model parameter set derived by the temporally previous coded video unit inside a current coding tree unit (CTU) or a current CTU row is stored.

In some embodiments, the model parameter set derived by the temporally previous coded video unit inside a current slice or a current tile or a current picture is stored.

In some embodiments, the model parameter set derived by the temporally previous coded video unit inside a previous coded coding tree unit (CTU) or CTU row or a co-located CTU or CTU row is stored.

In some embodiments, the model parameter set derived by the temporally previous coded video unit inside a previous coded slice or a previous coded tile or a previous coded picture is stored.

In some embodiments, a history or temporal or spatial model parameter set is reused by the current video unit.

In some embodiments, coefficients inside the model parameter set are reused by the current video unit.

In some embodiments, at least one coefficient inside the model parameter set is reused by the current video unit, the at least one coefficient corresponding to one of: a spatial tap, a nonlinear tap, or a bias tap.

In some embodiments, a filter model is stored and reused by the current video unit, the filter model comprising at least one of: a filter shape, a filter tap, a filter term, or an offset.

In some embodiments, whether and how a multi-model or a multi-filter is applied is stored and reused by the current video unit.

In some embodiments, at least one of: a threshold for the multi-model or multi-filter, or a model index of multiple downsample filter (MDF) is reused by the current video unit.

In some embodiments, the method 1900 further comprises: determining a reference sample from a history or temporal CCRM or intraTMP or IBC coded video unit; and reusing the reference sample by the current video unit.

In some embodiments, a reference area or template from a history or temporal CCRM or intraTMP or IBC coded video unit is reused by the current video unit.

In some embodiments, a history or temporal or spatial model parameter set list is maintained during the conversion.

In some embodiments, the model parameter set list comprises history or temporal model parameter sets during the conversion.

In some embodiments, the model parameter set list comprises at least one history or temporal model parameter set inside a current coding tree unit (CTU) or CTU row.

In some embodiments, the model parameter set list comprises at least one history or temporal model parameter set inside a current slice or a current tile or a current picture.

In some embodiments, the model parameter set list comprises up to N candidates, N being 12.

In some embodiments, the model parameter set list follows a first in first out (FIFO) rule.

In some embodiments, the model parameter set list is updated.

In some embodiments, the model parameter set list is updated with pruning.

In some embodiments, the model parameter set list is updated by: checking whether a first candidate is identical with a second candidate in the model parameter set list; and in accordance with a determination that the first candidate is identical with the second candidate, removing the second candidate from the model parameter set list and adding the first candidate into the model parameter set list.

In some embodiments, the model parameter set list is updated without pruning.

In some embodiments, the model parameter set list is reset for each coding tree unit (CTU) or CTU row.

In some embodiments, the model parameter set list is reset for each slice, each tile or each picture.

In some embodiments, a candidate index of a candidate is included in the bitstream or derived or predefined to indicate which candidate is selected.

In some embodiments, a model parameter set of a CCRM or intraTMP filter coded video unit or an IBC filter coded video unit is stored and used for filtering a subsequent CCRM or intra TMP or IBC coded video unit in a current picture.

In some embodiments, the model parameter set is stored in a history-based look-up table.

In some embodiments, a maximum size of the history-based look-up table is predefined.

In some embodiments, an element inserted into the history-based look-up table follows a first in first out (FIFO) order.

In some embodiments, a model parameter set of a CCRM or intraTMP or IBC filter coded video unit is stored and used for filtering a future CCRM or intraTMP or IBC filter coded video unit in a subsequent picture.

In some embodiments, the model parameter set is stored in a temporal buffer.

In some embodiments, the model parameter set is treated as a temporal buffer associated with a reference picture.

In some embodiments, the model parameter inheritance comprises a spatial adjacent based model parameter inheritance.

In some embodiments, a model parameter set derived by a spatial adjacent previous CCRM or intraTMP or IBC coded video unit is stored at an encoder and a decoder for the conversion.

In some embodiments, the model parameter set derived by the spatial adjacent previous CCRM or intraTMP or IBC coded video unit inside a current coding tree unit (CTU) or a current CTU row is stored.

In some embodiments, the model parameter set derived by the spatial adjacent previous CCRM or intraTMP or IBC coded video unit inside a current slice or a current tile or a current picture is stored.

In some embodiments, the model parameter set derived by the spatial adjacent previous CCRM or intraTMP or IBC coded video unit inside a previous coded coding tree unit (CTU) or CTU row or a co-located CTU or CTU row is stored.

In some embodiments, the model parameter set derived by the spatial adjacent previous CCRM or intraTMP or IBC coded video unit inside a previous coded slice or a previous coded tile or a previous coded picture is stored.

In some embodiments, a spatial adjacent model parameter set is reused by the current video unit.

In some embodiments, coefficients inside the model parameter set are reused by the current video unit.

In some embodiments, at least one coefficient inside the model parameter set is reused by the current video unit, the at least one coefficient corresponding to one of: a spatial tap, a nonlinear tap, or a bias tap.

In some embodiments, a filter model is stored and reused by the current video unit, the filter model comprising at least one of: a filter shape, a filter tap, a filter term, or an offset.

In some embodiments, whether and how a multi-model or a multi-filter is applied is stored and reused by the current video unit.

In some embodiments, at least one of: a threshold for the multi-model or multi-filter, or a model index of multiple downsample filter (MDF) is reused by the current video unit.

In some embodiments, the method 1900 further comprises: determining a reference sample from a spatial adjacent CCRM or intraTMP or IBC coded video unit; and reusing the reference sample by the current video unit.

In some embodiments, a reference area or template from a spatial adjacent CCRM or intraTMP or IBC coded video unit is reused by the current video unit.

In some embodiments, a spatial adjacent model parameter set list is maintained during the conversion.

In some embodiments, the model parameter set list comprises spatial adjacent model parameter sets during the conversion.

In some embodiments, the model parameter set list comprises at least one spatial adjacent model parameter set inside a current coding tree unit (CTU) or CTU row.

In some embodiments, the model parameter set list comprises at least one spatial adjacent model parameter set inside a current slice or a current tile or a current picture.

In some embodiments, the model parameter set list comprises up to N candidates, N being 6.

In some embodiments, the model parameter set list follows a first in first out (FIFO) rule.

In some embodiments, the model parameter set list is updated.

In some embodiments, the model parameter set list is updated with pruning.

In some embodiments, the model parameter set list is updated by: checking whether a first candidate is identical with a second candidate in the model parameter set list; and in accordance with a determination that the first candidate is identical with the second candidate, removing the second candidate from the model parameter set list and adding the first candidate into the model parameter set list.

In some embodiments, the model parameter set list is updated without pruning.

In some embodiments, the model parameter set list is reset for each video unit.

In some embodiments, a candidate index of a candidate is included in the bitstream or derived or predefined to indicate which candidate is selected.

In some embodiments, the model parameter inheritance comprises a spatial non-adjacent based model parameter inheritance.

In some embodiments, a model parameter set derived by a spatial non-adjacent previous CCRM or intraTMP or IBC coded video unit is stored at an encoder and a decoder for the conversion.

In some embodiments, the model parameter set derived by the spatial non-adjacent previous CCRM or intraTMP or IBC coded video unit inside a current coding tree unit (CTU) or a current CTU row is stored.

In some embodiments, the model parameter set derived by the spatial non-adjacent previous CCRM or intraTMP or IBC coded video unit inside a current slice or a current tile or a current picture is stored.

In some embodiments, the model parameter set derived by the spatial non-adjacent previous CCRM or intraTMP or IBC coded video unit inside a previous coded coding tree unit (CTU) or CTU row or a co-located CTU or CTU row is stored.

In some embodiments, the model parameter set derived by the spatial non-adjacent previous CCRM or intraTMP or IBC coded video unit inside a previous coded slice or a previous coded tile or a previous coded picture is stored.

In some embodiments, a spatial non-adjacent model parameter set is reused by the current video unit.

In some embodiments, coefficients inside the model parameter set are reused by the current video unit.

In some embodiments, at least one coefficient inside the model parameter set is reused by the current video unit, the at least one coefficient corresponding to one of: a spatial tap, a nonlinear tap, or a bias tap.

In some embodiments, a filter model is stored and reused by the current video unit, the filter model comprising at least one of: a filter shape, a filter tap, a filter term, or an offset.

In some embodiments, whether and how a multi-model or a multi-filter is applied is stored and reused by the current video unit.

In some embodiments, at least one of: a threshold for the multi-model or multi-filter, or a model index of multiple downsample filter (MDF) is reused by the current video unit.

In some embodiments, the method 1900 further comprises: determining a reference sample from a spatial non-adjacent CCRM or intraTMP or IBC coded video unit; and reusing the reference sample by the current video unit.

In some embodiments, a reference area or template from a spatial non-adjacent CCRM or intraTMP or IBC coded video unit is reused by the current video unit.

In some embodiments, a spatial non-adjacent model parameter set list is maintained during the conversion.

In some embodiments, the model parameter set list comprises spatial non-adjacent model parameter sets during the conversion.

In some embodiments, the model parameter set list comprises at least one spatial non-adjacent model parameter set inside a current coding tree unit (CTU) or CTU row.

In some embodiments, the model parameter set list comprises at least one spatial non-adjacent model parameter set inside a current slice or a current tile or a current picture.

In some embodiments, the model parameter set list comprises up to N candidates, N being 6.

In some embodiments, the model parameter set list follows a first in first out (FIFO) rule.

In some embodiments, the model parameter set list is updated.

In some embodiments, the model parameter set list is updated with pruning.

In some embodiments, the model parameter set list is updated by: checking whether a first candidate is identical with a second candidate in the model parameter set list; and in accordance with a determination that the first candidate is identical with the second candidate, removing the second candidate from the model parameter set list and adding the first candidate into the model parameter set list.

In some embodiments, the model parameter set list is updated without pruning.

In some embodiments, the model parameter set list is reset for each video unit.

In some embodiments, the model parameter set list is reset for each coding tree unit (CTU) or CTU row.

In some embodiments, the model parameter set list is reset for each slice, each tile or each picture.

In some embodiments, a candidate index of a candidate is included in the bitstream or derived or predefined to indicate which candidate is selected.

In some embodiments, spatial parameters are inherited from at least one of: an adjacent neighboring block, or a non-adjacent neighboring block.

In some embodiments, the adjacent neighboring block comprises a block used to inherit motion information in merge mode.

In some embodiments, the non-adjacent neighboring block comprises a block used to inherit motion information in merge mode.

In some embodiments, a position of the adjacent neighboring block or a position of the non-adjacent neighboring block is based on at least one of: a position of the current video unit, a width of the current video unit, or a height of the current video unit.

In some embodiments, the model parameter inheritance comprises a predefined or defaulted based model parameter set inheritance.

In some embodiments, at least one predefined model parameter set is stored at an encoder and a decoder for the conversion.

In some embodiments, a predefined model parameter set is used for the current video unit.

In some embodiments, a candidate index is included in the bitstream or derived or predefined to indicate which predefined model parameter set is selected.

In some embodiments, the method 1900 further comprises: determining a model candidate list for the current video unit in a CCRM or intraTMP or IBC model parameter inheritance mode.

In some embodiments, at least one spatial candidate is inserted in the model candidate list prior to other types of candidates.

In some embodiments, candidates in the model candidate list follow an order of spatial adjacent candidates, spatial non-adjacent candidates, history-based candidates, temporal candidates, default candidates.

In some embodiments, the method 1900 further comprises: applying a template cost based reordering process to the model candidate list during a generation of the model candidate list.

In some embodiments, a template cost is determined for a potential candidate to be put into the model candidate list by minimizing a sum of absolute difference (SAD) between model predicted samples and reconstructed samples in a training region.

In some embodiments, an order of potential candidates to be put in the model candidate list is reordered based on template costs in an ascending order.

In some embodiments, the method 1900 further comprises: applying a template cost based reordering process to the model candidate list after a construction of the model candidate list.

In some embodiments, a template cost is determined for a potential candidate to be put into the model candidate list by minimizing a sum of absolute difference (SAD) between model predicted samples and reconstructed samples in a training region.

In some embodiments, an order of potential candidates to be put in the model candidate list is reordered based on template costs in an ascending order.

In some embodiments, a checking order of spatial adjacent model candidates is same as spatial adjacent merge candidates for a merge list derivation.

In some embodiments, a checking order of spatial non-adjacent model candidates is same as spatial adjacent merge candidates for a merge list derivation.

In some embodiments, a checking order of temporal model candidates is same as temporal merge candidates for a merge list derivation.

In some embodiments, a set of shifted temporal model candidates is inserted into the model candidate list, and a shift factor is determined based on a motion vector or a block vector of a neighbor block.

In some embodiments, a first syntax element (SE) is included in the bitstream to indicate whether an inheritance mode is applied.

In some embodiments, the first syntax element comprises a flag.

In some embodiments, the first syntax element is coded with at least one context model.

In some embodiments, the first syntax element is bypass coded.

In some embodiments, the first syntax element is coded if the current video unit is coded with a CCRM mode.

In some embodiments, a second syntax element is included in the bitstream to indicate which candidate in a candidate list is used.

In some embodiments, the second syntax element is binarized as a truncated-unary code or fixed-length code or exponential Golomb code.

In some embodiments, a bin of the second syntax element is coded with at least one context model.

In some embodiments, a bin of the second syntax element is bypass coded.

In some embodiments, the second syntax element is included in the bitstream if a first syntax element indicates that an inheritance mode is applied.

In some embodiments, the method is applied to a plurality of color components together.

In some embodiments, the plurality of color components comprises a Cb component and a Cr component.

In some embodiments, the plurality of color components shares a same candidate list.

In some embodiments, the plurality of color components shares at least one same syntax element.

In some embodiments, sums of absolute differences (SADs) of templates of the plurality of color components are summed to obtain a template cost.

In some embodiments, the method is applied to a plurality of color components separately.

In some embodiments, the plurality of color components comprises a Cb component and a Cr component.

In some embodiments, the plurality of color components has different candidate lists.

In some embodiments, the plurality of color components has at least one same syntax element.

In some embodiments, sums of absolute differences (SADs) of templates of the plurality of color components are considered separately.

In some embodiments, a parameter of an intraTMP filter and an IBC filter parameter is allowed to be inherited to generate a luma prediction for the current video unit in a non-intra mode.

In some embodiments, intraTMP filter parameters are allowed to be inherited to generate a luma prediction for the current video unit in an intra TMP mode.

In some embodiments, IBC filter parameters are allowed to be inherited to generate a luma prediction for the current video unit in an IBC mode.

In some embodiments, CCRM filter parameters are allowed to be inherited to generate a chroma prediction for the current video unit in an inter or an IBC mode.

In some embodiments, a default candidate is with fixed or predefined parameters and/or associated information.

In some embodiments, a default candidate is with parameters and/or associated information derived from existing candidates in a candidate list.

In some embodiments, the method is used in at least one of: a post-processing, or a pre-processing.

In some embodiments, the method is applied jointly or separately.

In some embodiments, a plurality of categories of model parameter sets are jointly inserted into an inheritance list.

In some embodiments, the inheritance list comprises up to N candidates, N being 12.

In some embodiments, the inheritance list is updated following a first in first out rule or a further rule.

In some embodiments, the inheritance list is updated with pruning.

In some embodiments, the inheritance list is updated by: checking whether a first candidate is identical with a second candidate in the inheritance list; and in accordance with a determination that the first candidate is identical with the second candidate, removing the second candidate from the inheritance list and adding the first candidate into the inheritance list.

In some embodiments, the inheritance list is updated without pruning.

In some embodiments, the inheritance list is reset for each coding tree unit (CTU) or CTU row.

In some embodiments, the inheritance list is reset for each slice or each tile or each picture.

In some embodiments, a candidate index of a candidate is included in the bitstream or derived or predefined to indicate which candidate is selected.

In some embodiments, the method is applied to at least one of: an in-loop filtering tool, a prediction tool, a pre-processing tool, or a post-processing tool in video coding.

In some embodiments, the current video unit comprises one of: a sequence, a picture, a sub-picture, a slice, a tile, a coding tree unit (CTU), a CTU row, groups of CTU, a coding unit (CU), a prediction unit (PU), a transform unit (TU), a coding tree block (CTB), a coding block (CB), a prediction block (PB), a transform block (TB), or a region containing more than one luma or chroma sample or pixel.

In some embodiments, information regarding whether to and/or how to apply the method is indicated in the bitstream.

In some embodiments, the information is indicated at one of: a sequence level, a group of pictures level, a picture level, a slice level, a tile group level, a sequence header, a picture header, a sequence parameter set (SPS), a video parameter set (VPS), a dependency parameter set (DPS), decoding capability information (DCI), a picture parameter set (PPS), an adaptation parameter sets (APS), a slice header, or a tile group header.

In some embodiments, the information is indicated at one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, information regarding whether to and/or how to apply the method is based on coded information, the coded information comprising at least one of: a block size, a color format, a single and/or dual tree partitioning, a color component, a slice type, or a picture type.

In some embodiments, the conversion comprises encoding the current video unit into the bitstream.

In some embodiments, the conversion comprises decoding the current video unit from the bitstream.

According to further embodiments of the present disclosure, a non-transitory computer-readable recording medium is provided. The non-transitory computer-readable recording medium stores a bitstream of a video which is generated by a method performed by an apparatus for video processing. The method comprises: performing a model parameter inheritance for a coding tool, the coding tool comprising at least one of: a cross-component model based residual coding (CCRM) tool, an intra template matching prediction (intraTMP) filter tool, or an intra block copy (IBC) filter tool, the model parameter inheritance comprising at least one of: a history based model parameter inheritance, a temporal based model parameter inheritance, or a spatial based model parameter inheritance; and generating the bitstream based on the model parameter inheritance.

According to still further embodiments of the present disclosure, a method for storing bitstream of a video is provided. The method comprises: performing a model parameter inheritance for a coding tool, the coding tool comprising at least one of: a cross-component model based residual coding (CCRM) tool, an intra template matching prediction (intraTMP) filter tool, or an intra block copy (IBC) filter tool, the model parameter inheritance comprising at least one of: a history based model parameter inheritance, a temporal based model parameter inheritance, or a spatial based model parameter inheritance; generating the bitstream based on the model parameter inheritance; and storing the bitstream in a non-transitory computer-readable recording medium.

Implementations of the present disclosure can be described in view of the following clauses, the features of which can be combined in any reasonable manner.

Clause 1. A method for video processing, comprising: performing, for a conversion between a current video unit of a video and a bitstream of the video, a model parameter inheritance for a coding tool, the coding tool comprising at least one of: a cross-component model based residual coding (CCRM) tool, an intra template matching prediction (intraTMP) filter tool, or an intra block copy (IBC) filter tool, the model parameter inheritance comprising at least one of: a history based model parameter inheritance, a temporal based model parameter inheritance, or a spatial based model parameter inheritance; and performing the conversion based on the model parameter inheritance.

Clause 2. The method of clause 1, wherein a model parameter set derived by a temporally previous coded video unit is stored at an encoder and a decoder for the conversion, the temporally previous coded video unit comprising at least one of: a temporally previous CCRM coded video unit, a temporally previous intraTMP coded video unit, or a temporally previous IBC coded video unit.

Clause 3. The method of clause 2, wherein the model parameter set derived by the temporally previous coded video unit inside a current coding tree unit (CTU) or a current CTU row is stored.

Clause 4. The method of clause 2, wherein the model parameter set derived by the temporally previous coded video unit inside a current slice or a current tile or a current picture is stored.

Clause 5. The method of clause 2, wherein the model parameter set derived by the temporally previous coded video unit inside a previous coded coding tree unit (CTU) or CTU row or a co-located CTU or CTU row is stored.

Clause 6. The method of clause 2, wherein the model parameter set derived by the temporally previous coded video unit inside a previous coded slice or a previous coded tile or a previous coded picture is stored.

Clause 7. The method of any of clauses 1-6, wherein a history or temporal or spatial model parameter set is reused by the current video unit.

Clause 8. The method of clause 7, wherein coefficients inside the model parameter set are reused by the current video unit.

Clause 9. The method of clause 7, wherein at least one coefficient inside the model parameter set is reused by the current video unit, the at least one coefficient corresponding to one of: a spatial tap, a nonlinear tap, or a bias tap.

Clause 10. The method of any of clauses 7-9, wherein a filter model is stored and reused by the current video unit, the filter model comprising at least one of: a filter shape, a filter tap, a filter term, or an offset.

Clause 11. The method of any of clauses 7-10, wherein whether and how a multi-model or a multi-filter is applied is stored and reused by the current video unit.

Clause 12. The method of clause 11, wherein at least one of: a threshold for the multi-model or multi-filter, or a model index of multiple downsample filter (MDF) is reused by the current video unit.

Clause 13. The method of any of clauses 1-12, further comprising: determining a reference sample from a history or temporal CCRM or intraTMP or IBC coded video unit; and reusing the reference sample by the current video unit.

Clause 14. The method of any of clauses 1-13, wherein a reference area or template from a history or temporal CCRM or intraTMP or IBC coded video unit is reused by the current video unit.

Clause 15. The method of any of clauses 1-14, wherein a history or temporal or spatial model parameter set list is maintained during the conversion.

Clause 16. The method of clause 15, wherein the model parameter set list comprises history or temporal model parameter sets during the conversion.

Clause 17. The method of clause 15, wherein the model parameter set list comprises at least one history or temporal model parameter set inside a current coding tree unit (CTU) or CTU row.

Clause 18. The method of clause 15, wherein the model parameter set list comprises at least one history or temporal model parameter set inside a current slice or a current tile or a current picture.

Clause 19. The method of clause 15, wherein the model parameter set list comprises up to N candidates, N being 12.

Clause 20. The method of clause 15, wherein the model parameter set list follows a first in first out (FIFO) rule.

Clause 21. The method of clause 15, wherein the model parameter set list is updated.

Clause 22. The method of clause 15, wherein the model parameter set list is updated with pruning.

Clause 23. The method of clause 22, wherein the model parameter set list is updated by: checking whether a first candidate is identical with a second candidate in the model parameter set list; and in accordance with a determination that the first candidate is identical with the second candidate, removing the second candidate from the model parameter set list and adding the first candidate into the model parameter set list.

Clause 24. The method of clause 15, wherein the model parameter set list is updated without pruning.

Clause 25. The method of clause 15, wherein the model parameter set list is reset for each coding tree unit (CTU) or CTU row.

Clause 26. The method of clause 15, wherein the model parameter set list is reset for each slice, each tile or each picture.

Clause 27. The method of clause 15, wherein a candidate index of a candidate is included in the bitstream or derived or predefined to indicate which candidate is selected.

Clause 28. The method of any of clauses 1-27, wherein a model parameter set of a CCRM or intraTMP filter coded video unit or an IBC filter coded video unit is stored and used for filtering a subsequent CCRM or intra TMP or IBC coded video unit in a current picture.

Clause 29. The method of clause 28, wherein the model parameter set is stored in a history-based look-up table.

Clause 30. The method of clause 29, wherein a maximum size of the history-based look-up table is predefined.

Clause 31. The method of clause 28, wherein an element inserted into the history-based look-up table follows a first in first out (FIFO) order.

Clause 32. The method of any of clauses 1-31, wherein a model parameter set of a CCRM or intraTMP or IBC filter coded video unit is stored and used for filtering a future CCRM or intraTMP or IBC filter coded video unit in a subsequent picture.

Clause 33. The method of clause 32, wherein the model parameter set is stored in a temporal buffer.

Clause 34. The method of clause 32, wherein the model parameter set is treated as a temporal buffer associated with a reference picture.

Clause 35. The method of any of clauses 1-34, wherein the model parameter inheritance comprises a spatial adjacent based model parameter inheritance.

Clause 36. The method of clause 35, wherein a model parameter set derived by a spatial adjacent previous CCRM or intraTMP or IBC coded video unit is stored at an encoder and a decoder for the conversion.

Clause 37. The method of clause 36, wherein the model parameter set derived by the spatial adjacent previous CCRM or intraTMP or IBC coded video unit inside a current coding tree unit (CTU) or a current CTU row is stored.

Clause 38. The method of clause 36, wherein the model parameter set derived by the spatial adjacent previous CCRM or intraTMP or IBC coded video unit inside a current slice or a current tile or a current picture is stored.

Clause 39. The method of clause 36, wherein the model parameter set derived by the spatial adjacent previous CCRM or intraTMP or IBC coded video unit inside a previous coded coding tree unit (CTU) or CTU row or a co-located CTU or CTU row is stored.

Clause 40. The method of clause 36, wherein the model parameter set derived by the spatial adjacent previous CCRM or intraTMP or IBC coded video unit inside a previous coded slice or a previous coded tile or a previous coded picture is stored.

Clause 41. The method of any of clauses 35-40, wherein a spatial adjacent model parameter set is reused by the current video unit.

Clause 42. The method of clause 41, wherein coefficients inside the model parameter set are reused by the current video unit.

Clause 43. The method of clause 41, wherein at least one coefficient inside the model parameter set is reused by the current video unit, the at least one coefficient corresponding to one of: a spatial tap, a nonlinear tap, or a bias tap.

Clause 44. The method of any of clauses 41-43, wherein a filter model is stored and reused by the current video unit, the filter model comprising at least one of: a filter shape, a filter tap, a filter term, or an offset.

Clause 45. The method of any of clauses 41-44, wherein whether and how a multi-model or a multi-filter is applied is stored and reused by the current video unit.

Clause 46. The method of clause 45, wherein at least one of: a threshold for the multi-model or multi-filter, or a model index of multiple downsample filter (MDF) is reused by the current video unit.

Clause 47. The method of any of clauses 35-46, further comprising: determining a reference sample from a spatial adjacent CCRM or intraTMP or IBC coded video unit; and reusing the reference sample by the current video unit.

Clause 48. The method of any of clauses 35-47, wherein a reference area or template from a spatial adjacent CCRM or intraTMP or IBC coded video unit is reused by the current video unit.

Clause 49. The method of any of clauses 35-48, wherein a spatial adjacent model parameter set list is maintained during the conversion.

Clause 50. The method of clause 49, wherein the model parameter set list comprises spatial adjacent model parameter sets during the conversion.

Clause 51. The method of clause 49, wherein the model parameter set list comprises at least one spatial adjacent model parameter set inside a current coding tree unit (CTU) or CTU row.

Clause 52. The method of clause 49, wherein the model parameter set list comprises at least one spatial adjacent model parameter set inside a current slice or a current tile or a current picture.

Clause 53. The method of clause 49, wherein the model parameter set list comprises up to N candidates, N being 6.

Clause 54. The method of clause 49, wherein the model parameter set list follows a first in first out (FIFO) rule.

Clause 55. The method of clause 49, wherein the model parameter set list is updated.

Clause 56. The method of clause 49, wherein the model parameter set list is updated with pruning.

Clause 57. The method of clause 56, wherein the model parameter set list is updated by: checking whether a first candidate is identical with a second candidate in the model parameter set list; and in accordance with a determination that the first candidate is identical with the second candidate, removing the second candidate from the model parameter set list and adding the first candidate into the model parameter set list.

Clause 58. The method of clause 49, wherein the model parameter set list is updated without pruning.

Clause 59. The method of clause 49, wherein the model parameter set list is reset for each video unit.

Clause 60. The method of clause 49, wherein a candidate index of a candidate is included in the bitstream or derived or predefined to indicate which candidate is selected.

Clause 61. The method of any of clauses 1-60, wherein the model parameter inheritance comprises a spatial non-adjacent based model parameter inheritance.

Clause 62. The method of clause 61, wherein a model parameter set derived by a spatial non-adjacent previous CCRM or intraTMP or IBC coded video unit is stored at an encoder and a decoder for the conversion.

Clause 63. The method of clause 62, wherein the model parameter set derived by the spatial non-adjacent previous CCRM or intraTMP or IBC coded video unit inside a current coding tree unit (CTU) or a current CTU row is stored.

Clause 64. The method of clause 62, wherein the model parameter set derived by the spatial non-adjacent previous CCRM or intraTMP or IBC coded video unit inside a current slice or a current tile or a current picture is stored.

Clause 65. The method of clause 62, wherein the model parameter set derived by the spatial non-adjacent previous CCRM or intraTMP or IBC coded video unit inside a previous coded coding tree unit (CTU) or CTU row or a co-located CTU or CTU row is stored.

Clause 66. The method of clause 62, wherein the model parameter set derived by the spatial non-adjacent previous CCRM or intraTMP or IBC coded video unit inside a previous coded slice or a previous coded tile or a previous coded picture is stored.

Clause 67. The method of any of clauses 61-66, wherein a spatial non-adjacent model parameter set is reused by the current video unit.

Clause 68. The method of clause 67, wherein coefficients inside the model parameter set are reused by the current video unit.

Clause 69. The method of clause 67, wherein at least one coefficient inside the model parameter set is reused by the current video unit, the at least one coefficient corresponding to one of: a spatial tap, a nonlinear tap, or a bias tap.

Clause 70. The method of any of clauses 67-69, wherein a filter model is stored and reused by the current video unit, the filter model comprising at least one of: a filter shape, a filter tap, a filter term, or an offset.

Clause 71. The method of any of clauses 67-70, wherein whether and how a multi-model or a multi-filter is applied is stored and reused by the current video unit.

Clause 72. The method of clause 71, wherein at least one of: a threshold for the multi-model or multi-filter, or a model index of multiple downsample filter (MDF) is reused by the current video unit.

Clause 73. The method of any of clauses 61-72, further comprising: determining a reference sample from a spatial non-adjacent CCRM or intraTMP or IBC coded video unit; and reusing the reference sample by the current video unit.

Clause 74. The method of any of clauses 61-73, wherein a reference area or template from a spatial non-adjacent CCRM or intraTMP or IBC coded video unit is reused by the current video unit.

Clause 75. The method of any of clauses 61-74, wherein a spatial non-adjacent model parameter set list is maintained during the conversion.

Clause 76. The method of clause 75, wherein the model parameter set list comprises spatial non-adjacent model parameter sets during the conversion.

Clause 77. The method of clause 75, wherein the model parameter set list comprises at least one spatial non-adjacent model parameter set inside a current coding tree unit (CTU) or CTU row.

Clause 78. The method of clause 75, wherein the model parameter set list comprises at least one spatial non-adjacent model parameter set inside a current slice or a current tile or a current picture.

Clause 79. The method of clause 75, wherein the model parameter set list comprises up to N candidates, N being 6.

Clause 80. The method of clause 75, wherein the model parameter set list follows a first in first out (FIFO) rule.

Clause 81. The method of clause 75, wherein the model parameter set list is updated.

Clause 82. The method of clause 75, wherein the model parameter set list is updated with pruning.

Clause 83. The method of clause 82, wherein the model parameter set list is updated by: checking whether a first candidate is identical with a second candidate in the model parameter set list; and in accordance with a determination that the first candidate is identical with the second candidate, removing the second candidate from the model parameter set list and adding the first candidate into the model parameter set list.

Clause 84. The method of clause 75, wherein the model parameter set list is updated without pruning.

Clause 85. The method of clause 75, wherein the model parameter set list is reset for each video unit.

Clause 86. The method of clause 75, wherein the model parameter set list is reset for each coding tree unit (CTU) or CTU row.

Clause 87. The method of clause 75, wherein the model parameter set list is reset for each slice, each tile or each picture.

Clause 88. The method of clause 75, wherein a candidate index of a candidate is included in the bitstream or derived or predefined to indicate which candidate is selected.

Clause 89. The method of any of clauses 1-88, wherein spatial parameters are inherited from at least one of: an adjacent neighboring block, or a non-adjacent neighboring block.

Clause 90. The method of clause 89, wherein the adjacent neighboring block comprises a block used to inherit motion information in merge mode.

Clause 91. The method of clause 89, wherein the non-adjacent neighboring block comprises a block used to inherit motion information in merge mode.

Clause 92. The method of any of clauses 89-91, wherein a position of the adjacent neighboring block or a position of the non-adjacent neighboring block is based on at least one of: a position of the current video unit, a width of the current video unit, or a height of the current video unit.

Clause 93. The method of any of clauses 1-92, wherein the model parameter inheritance comprises a predefined or defaulted based model parameter set inheritance.

Clause 94. The method of clause 93, wherein at least one predefined model parameter set is stored at an encoder and a decoder for the conversion.

Clause 95. The method of clause 93, wherein a predefined model parameter set is used for the current video unit.

Clause 96. The method of clause 93, wherein a candidate index is included in the bitstream or derived or predefined to indicate which predefined model parameter set is selected.

Clause 97. The method of any of clauses 1-96, further comprising: determining a model candidate list for the current video unit in a CCRM or intraTMP or IBC model parameter inheritance mode.

Clause 98. The method of clause 97, wherein at least one spatial candidate is inserted in the model candidate list prior to other types of candidates.

Clause 99. The method of clause 97, wherein candidates in the model candidate list follow an order of spatial adjacent candidates, spatial non-adjacent candidates, history-based candidates, temporal candidates, default candidates.

Clause 100. The method of any of clauses 97-99, further comprising: applying a template cost based reordering process to the model candidate list during a generation of the model candidate list.

Clause 101. The method of clause 100, wherein a template cost is determined for a potential candidate to be put into the model candidate list by minimizing a sum of absolute difference (SAD) between model predicted samples and reconstructed samples in a training region.

Clause 102. The method of clause 100, wherein an order of potential candidates to be put in the model candidate list is reordered based on template costs in an ascending order.

Clause 103. The method of any of clauses 97-99, further comprising: applying a template cost based reordering process to the model candidate list after a construction of the model candidate list.

Clause 104. The method of clause 103, wherein a template cost is determined for a potential candidate to be put into the model candidate list by minimizing a sum of absolute difference (SAD) between model predicted samples and reconstructed samples in a training region.

Clause 105. The method of clause 103, wherein an order of potential candidates to be put in the model candidate list is reordered based on template costs in an ascending order.

Clause 106. The method of any of clauses 97-105, wherein a checking order of spatial adjacent model candidates is same as spatial adjacent merge candidates for a merge list derivation.

Clause 107. The method of any of clauses 97-105, wherein a checking order of spatial non-adjacent model candidates is same as spatial adjacent merge candidates for a merge list derivation.

Clause 108. The method of any of clauses 97-105, wherein a checking order of temporal model candidates is same as temporal merge candidates for a merge list derivation.

Clause 109. The method of clause 108, wherein a set of shifted temporal model candidates is inserted into the model candidate list, and a shift factor is determined based on a motion vector or a block vector of a neighbor block.

Clause 110. The method of any of clauses 1-109, wherein a first syntax element (SE) is included in the bitstream to indicate whether an inheritance mode is applied.

Clause 111. The method of clause 110, wherein the first syntax element comprises a flag.

Clause 112. The method of clause 110 or 111, wherein the first syntax element is coded with at least one context model.

Clause 113. The method of clause 110 or 111, wherein the first syntax element is bypass coded.

Clause 114. The method of clause 110 or 111, wherein the first syntax element is coded if the current video unit is coded with a CCRM mode.

Clause 115. The method of any of clauses 1-114, wherein a second syntax element is included in the bitstream to indicate which candidate in a candidate list is used.

Clause 116. The method of clause 115, wherein the second syntax element is binarized as a truncated-unary code or fixed-length code or exponential Golomb code.

Clause 117. The method of clause 115, wherein a bin of the second syntax element is coded with at least one context model.

Clause 118. The method of clause 115, wherein a bin of the second syntax element is bypass coded.

Clause 119. The method of clause 115, wherein the second syntax element is included in the bitstream if a first syntax element indicates that an inheritance mode is applied.

Clause 120. The method of any of clauses 1-119, wherein the method is applied to a plurality of color components together.

Clause 121. The method of clause 120, wherein the plurality of color components comprises a Cb component and a Cr component.

Clause 122. The method of clause 120 or 121, wherein the plurality of color components shares a same candidate list.

Clause 123. The method of clause 120 or 121, wherein the plurality of color components shares at least one same syntax element.

Clause 124. The method of clause 120 or 121, wherein sums of absolute differences (SADs) of templates of the plurality of color components are summed to obtain a template cost.

Clause 125. The method of any of clauses 1-119, wherein the method is applied to a plurality of color components separately.

Clause 126. The method of clause 125, wherein the plurality of color components comprises a Cb component and a Cr component.

Clause 127. The method of clause 125 or 126, wherein the plurality of color components has different candidate lists.

Clause 128. The method of clause 125 or 126, wherein the plurality of color components has at least one same syntax element.

Clause 129. The method of clause 125 or 126, wherein sums of absolute differences (SADs) of templates of the plurality of color components are considered separately.

Clause 130. The method of any of clauses 1-129, wherein a parameter of an intraTMP filter and an IBC filter parameter is allowed to be inherited to generate a luma prediction for the current video unit in a non-intra mode.

Clause 131. The method of any of clauses 1-129, wherein intraTMP filter parameters are allowed to be inherited to generate a luma prediction for the current video unit in an intra TMP mode.

Clause 132. The method of any of clauses 1-129, wherein IBC filter parameters are allowed to be inherited to generate a luma prediction for the current video unit in an IBC mode.

Clause 133. The method of any of clauses 1-132, wherein CCRM filter parameters are allowed to be inherited to generate a chroma prediction for the current video unit in an inter or an IBC mode.

Clause 134. The method of any of clauses 1-133, wherein a default candidate is with fixed or predefined parameters and/or associated information.

Clause 135. The method of any of clauses 1-133, wherein a default candidate is with parameters and/or associated information derived from existing candidates in a candidate list.

Clause 136. The method of any of clauses 1-135, wherein the method is used in at least one of: a post-processing, or a pre-processing.

Clause 137. The method of any of clauses 1-136, wherein the method is applied jointly or separately.

Clause 138. The method of clause 137, wherein a plurality of categories of model parameter sets are jointly inserted into an inheritance list.

Clause 139. The method of clause 138, wherein the inheritance list comprises up to N candidates, N being 12.

Clause 140. The method of clause 138 or 139, wherein the inheritance list is updated following a first in first out rule or a further rule.

Clause 141. The method of clause 138 or 139, wherein the inheritance list is updated with pruning.

Clause 142. The method of clause 141, wherein the inheritance list is updated by: checking whether a first candidate is identical with a second candidate in the inheritance list; and in accordance with a determination that the first candidate is identical with the second candidate, removing the second candidate from the inheritance list and adding the first candidate into the inheritance list.

Clause 143. The method of clause 138 or 139, wherein the inheritance list is updated without pruning.

Clause 144. The method of clause 138 or 139, wherein the inheritance list is reset for each coding tree unit (CTU) or CTU row.

Clause 145. The method of clause 138 or 139, wherein the inheritance list is reset for each slice or each tile or each picture.

Clause 146. The method of any of clauses 138-145, wherein a candidate index of a candidate is included in the bitstream or derived or predefined to indicate which candidate is selected.

Clause 147. The method of any of clauses 1-146, wherein the method is applied to at least one of: an in-loop filtering tool, a prediction tool, a pre-processing tool, or a post-processing tool in video coding.

Clause 148. The method of any of clauses 1-147, wherein the current video unit comprises one of: a sequence, a picture, a sub-picture, a slice, a tile, a coding tree unit (CTU), a CTU row, groups of CTU, a coding unit (CU), a prediction unit (PU), a transform unit (TU), a coding tree block (CTB), a coding block (CB), a prediction block (PB), a transform block (TB), or a region containing more than one luma or chroma sample or pixel.

Clause 149. The method of any of clauses 1-148, wherein information regarding whether to and/or how to apply the method is indicated in the bitstream.

Clause 150. The method of clause 149, wherein the information is indicated at one of: a sequence level, a group of pictures level, a picture level, a slice level, a tile group level, a sequence header, a picture header, a sequence parameter set (SPS), a video parameter set (VPS), a dependency parameter set (DPS), decoding capability information (DCI), a picture parameter set (PPS), an adaptation parameter sets (APS), a slice header, or a tile group header.

Clause 151. The method of clause 149, wherein the information is indicated at one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 152. The method of any of clauses 1-148, wherein information regarding whether to and/or how to apply the method is based on coded information, the coded information comprising at least one of: a block size, a color format, a single and/or dual tree partitioning, a color component, a slice type, or a picture type.

Clause 153. The method of any of clauses 1-152, wherein the conversion comprises encoding the current video unit into the bitstream.

Clause 154. The method of any of clauses 1-152, wherein the conversion comprises decoding the current video unit from the bitstream.

Clause 155. An apparatus for video processing comprising a processor and a non-transitory memory with instructions thereon, wherein the instructions upon execution by the processor, cause the processor to perform a method in accordance with any of clauses 1-154.

Clause 156. A non-transitory computer-readable storage medium storing instructions that cause a processor to perform a method in accordance with any of clauses 1-154.

Clause 157. A non-transitory computer-readable recording medium storing a bitstream of a video which is generated by a method performed by an apparatus for video processing, wherein the method comprises: performing a model parameter inheritance for a coding tool, the coding tool comprising at least one of: a cross-component model based residual coding (CCRM) tool, an intra template matching prediction (intraTMP) filter tool, or an intra block copy (IBC) filter tool, the model parameter inheritance comprising at least one of: a history based model parameter inheritance, a temporal based model parameter inheritance, or a spatial based model parameter inheritance; and generating the bitstream based on the model parameter inheritance.

Clause 158. A method for storing a bitstream of a video, comprising: performing a model parameter inheritance for a coding tool, the coding tool comprising at least one of: a cross-component model based residual coding (CCRM) tool, an intra template matching prediction (intraTMP) filter tool, or an intra block copy (IBC) filter tool, the model parameter inheritance comprising at least one of: a history based model parameter inheritance, a temporal based model parameter inheritance, or a spatial based model parameter inheritance; generating the bitstream based on the model parameter inheritance; and storing the bitstream in a non-transitory computer-readable recording medium.

### Example Device

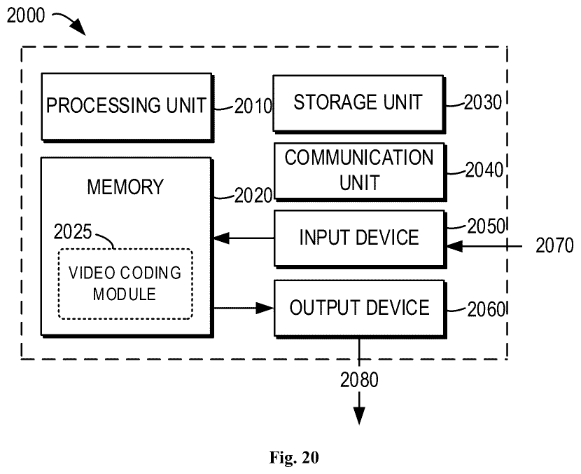

FIG. 20 illustrates a block diagram of a computing device 2000 in which various embodiments of the present disclosure can be implemented. The computing device 2000 may be implemented as or included in the source device 110 (or the video encoder 114 or 200) or the destination device 120 (or the video decoder 124 or 300).

It would be appreciated that the computing device 2000 shown in FIG. 20 is merely for purpose of illustration, without suggesting any limitation to the functions and scopes of the embodiments of the present disclosure in any manner.

As shown in FIG. 20, the computing device 2000 includes a general-purpose computing device 2000. The computing device 2000 may at least comprise one or more processors or processing units 2010, a memory 2020, a storage unit 2030, one or more communication units 2040, one or more input devices 2050, and one or more output devices 2060.

In some embodiments, the computing device 2000 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2000 can support any type of interface to a user (such as “wearable” circuitry and the like).

The processing unit 2010 may be a physical or virtual processor and can implement various processes based on programs stored in the memory 2020. In a multi-processor system, multiple processing units execute computer executable instructions in parallel so as to improve the parallel processing capability of the computing device 2000. The processing unit 2010 may also be referred to as a central processing unit (CPU), a microprocessor, a controller or a microcontroller.

The computing device 2000 typically includes various computer storage medium. Such medium can be any medium accessible by the computing device 2000, including, but not limited to, volatile and non-volatile medium, or detachable and non-detachable medium. The memory 2020 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2030 may be any detachable or non-detachable medium and may include a machine-readable medium such as a memory, flash memory drive, magnetic disk or another other media, which can be used for storing information and/or data and can be accessed in the computing device 2000.

The computing device 2000 may further include additional detachable/non-detachable, volatile/non-volatile memory medium. Although not shown in FIG. 20, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2040 communicates with a further computing device via the communication medium. In addition, the functions of the components in the computing device 2000 can be implemented by a single computing cluster or multiple computing machines that can communicate via communication connections. Therefore, the computing device 2000 can operate in a networked environment using a logical connection with one or more other servers, networked personal computers (PCs) or further general network nodes.

The input device 2050 may be one or more of a variety of input devices, such as a mouse, keyboard, tracking ball, voice-input device, and the like. The output device 2060 may be one or more of a variety of output devices, such as a display, loudspeaker, printer, and the like. By means of the communication unit 2040, the computing device 2000 can further communicate with one or more external devices (not shown) such as the storage devices and display device, with one or more devices enabling the user to interact with the computing device 2000, or any devices (such as a network card, a modem and the like) enabling the computing device 2000 to communicate with one or more other computing devices, if required. Such communication can be performed via input/output (I/O) interfaces (not shown).

In some embodiments, instead of being integrated in a single device, some or all components of the computing device 2000 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2000 may be used to implement video encoding/decoding in embodiments of the present disclosure. The memory 2020 may include one or more video coding modules 2025 having one or more program instructions. These modules are accessible and executable by the processing unit 2010 to perform the functionalities of the various embodiments described herein.

In the example embodiments of performing video encoding, the input device 2050 may receive video data as an input 2070 to be encoded. The video data may be processed, for example, by the video coding module 2025, to generate an encoded bitstream. The encoded bitstream may be provided via the output device 2060 as an output 2080.

In the example embodiments of performing video decoding, the input device 2050 may receive an encoded bitstream as the input 2070. The encoded bitstream may be processed, for example, by the video coding module 2025, to generate decoded video data. The decoded video data may be provided via the output device 2060 as the output 2080.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

What is claimed is:

1. A method for video processing, comprising:
performing, for a conversion between a current video unit of a video and a bitstream of the video, a model parameter inheritance for a coding tool, the coding tool comprising at least one of: a cross-component model based residual coding (CCRM) tool, an intra template matching prediction (intraTMP) filter tool, or an intra block copy (IBC) filter tool, the model parameter inheritance comprising at least one of: a history based model parameter inheritance, a temporal based model parameter inheritance, or a spatial based model parameter inheritance; and
performing the conversion based on the model parameter inheritance.

2. The method of claim 1, wherein a model parameter set derived by a temporally previous coded video unit is stored at an encoder and a decoder for the conversion, the temporally previous coded video unit comprising at least one of: a temporally previous CCRM coded video unit, a temporally previous intraTMP coded video unit, or a temporally previous IBC coded video unit.

3. The method of claim 2, wherein the model parameter set derived by the temporally previous coded video unit inside a current coding tree unit (CTU) or a current CTU row is stored, or
wherein the model parameter set derived by the temporally previous coded video unit inside a current slice or a current tile or a current picture is stored.

4. The method of claim 1, wherein a history or temporal or spatial model parameter set is reused by the current video unit, wherein coefficients inside the model parameter set are reused by the current video unit.

5. The method of claim 1, wherein a history or temporal or spatial model parameter set list is maintained during the conversion.

6. The method of claim 5, wherein the model parameter set list comprises at least one history or temporal model parameter set inside a current coding tree unit (CTU) or CTU row, or
wherein the model parameter set list comprises at least one history or temporal model parameter set inside a current slice or a current tile or a current picture, or
wherein the model parameter set list follows a first in first out (FIFO) rule, or
wherein the model parameter set list is updated with pruning, or
wherein the model parameter set list is reset for each coding tree unit (CTU) or CTU row, or
wherein the model parameter set list is reset for each slice, each tile or each picture.

7. The method of claim 1, wherein a model parameter set of a CCRM or intraTMP filter coded video unit or an IBC filter coded video unit is stored and used for filtering a subsequent CCRM or intra TMP or IBC coded video unit in a current picture,
wherein the model parameter set is stored in a history-based look-up table.

8. The method of claim 1, wherein the model parameter inheritance comprises a spatial adjacent based model parameter inheritance,
wherein a model parameter set derived by a spatial adjacent previous CCRM or intraTMP or IBC coded video unit is stored at an encoder and a decoder for the conversion, and/or
wherein a spatial adjacent model parameter set is reused by the current video unit, and/or
wherein a spatial adjacent model parameter set list is maintained during the conversion,
wherein the model parameter set list comprises at least one spatial adjacent model parameter set inside a current coding tree unit (CTU) or CTU row, or
wherein the model parameter set list comprises at least one spatial adjacent model parameter set inside a current slice or a current tile or a current picture, or
wherein the model parameter set list follows a first in first out (FIFO) rule, or
wherein the model parameter set list is updated with pruning.

9. The method of claim 1, wherein the model parameter inheritance comprises a spatial non-adjacent based model parameter inheritance,
wherein a model parameter set derived by a spatial non-adjacent previous CCRM or intraTMP or IBC coded video unit is stored at an encoder and a decoder for the conversion, and/or
wherein a spatial non-adjacent model parameter set is reused by the current video unit, and/or
wherein a spatial non-adjacent model parameter set list is maintained during the conversion,
wherein the model parameter set list comprises at least one spatial non-adjacent model parameter set inside a current coding tree unit (CTU) or CTU row, or
wherein the model parameter set list comprises at least one spatial non-adjacent model parameter set inside a current slice or a current tile or a current picture, or
wherein the model parameter set list follows a first in first out (FIFO) rule, or
wherein the model parameter set list is updated with pruning.

10. The method of claim 1, wherein spatial parameters are inherited from at least one of: an adjacent neighboring block, or a non-adjacent neighboring block,
wherein the adjacent neighboring block comprises a block used to inherit motion information in merge mode, or
wherein the non-adjacent neighboring block comprises a block used to inherit motion information in merge mode.

11. The method of claim 1, further comprising:
determining a model candidate list for the current video unit in a CCRM or intraTMP or IBC model parameter inheritance mode,
wherein at least one spatial candidate is inserted in the model candidate list prior to other types of candidates, or
wherein candidates in the model candidate list follow an order of spatial adjacent candidates, spatial non-adjacent candidates, history-based candidates, temporal candidates, default candidates, and/or
wherein the method further comprises one of:
applying a template cost based reordering process to the model candidate list during a generation of the model candidate list, or
applying a template cost based reordering process to the model candidate list after a construction of the model candidate list.

12. The method of claim 1, wherein a first syntax element (SE) is included in the bitstream to indicate whether an inheritance mode is applied,
wherein the first syntax element comprises a flag, or
wherein the first syntax element is coded with at least one context model.

13. The method of claim 1, wherein a second syntax element is included in the bitstream to indicate which candidate in a candidate list is used,
wherein the second syntax element is binarized as a truncated-unary code or fixed-length code or exponential Golomb code, or
wherein a bin of the second syntax element is coded with at least one context model.

14. The method of claim 1, wherein the method is applied to a plurality of color components together,
wherein the plurality of color components comprises a Cb component and a Cr component,
wherein the plurality of color components shares a same candidate list, or
wherein the plurality of color components shares at least one same syntax element.

15. The method of claim 1, wherein the method is applied to a plurality of color components separately,
wherein the plurality of color components comprises a Cb component and a Cr component,
wherein the plurality of color components has different candidate lists, or
wherein the plurality of color components has at least one same syntax element.

16. The method of claim 1, wherein a plurality of categories of model parameter sets are jointly inserted into an inheritance list,
wherein the inheritance list is updated following a first in first out rule or a further rule, or
wherein the inheritance list is updated with pruning, or
wherein the inheritance list is reset for each coding tree unit (CTU) or CTU row, or
wherein the inheritance list is reset for each slice or each tile or each picture.

17. The method of claim 1, wherein the conversion comprises encoding the current video unit the bitstream, or
wherein the conversion comprises decoding the current video unit from the bitstream.

18. An apparatus for video processing comprising a processor and a non-transitory memory with instructions thereon, wherein the instructions upon execution by the processor, cause the processor to:
perform, for a conversion between a current video unit of a video and a bitstream of the video, a model parameter inheritance for a coding tool, the coding tool comprising at least one of: a cross-component model based residual coding (CCRM) tool, an intra template matching prediction (intraTMP) filter tool, or an intra block copy (IBC) filter tool, the model parameter inheritance comprising at least one of: a history based model parameter inheritance, a temporal based model parameter inheritance, or a spatial based model parameter inheritance; and
perform the conversion based on the model parameter inheritance.

19. A non-transitory computer-readable storage medium storing instructions that cause a processor to perform operations comprising:
performing, for a conversion between a current video unit of a video and a bitstream of the video, a model parameter inheritance for a coding tool, the coding tool comprising at least one of: a cross-component model based residual coding (CCRM) tool, an intra template matching prediction (intraTMP) filter tool, or an intra block copy (IBC) filter tool, the model parameter inheritance comprising at least one of: a history based model parameter inheritance, a temporal based model parameter inheritance, or a spatial based model parameter inheritance; and
performing the conversion based on the model parameter inheritance.

20. A non-transitory computer-readable recording medium storing a bitstream of a video which is generated by a method performed by an apparatus for video processing, wherein the method comprises:
performing a model parameter inheritance for a coding tool, the coding tool comprising at least one of: a cross-component model based residual coding (CCRM) tool, an intra template matching prediction (intraTMP) filter tool, or an intra block copy (IBC) filter tool, the model parameter inheritance comprising at least one of: a history based model parameter inheritance, a temporal based model parameter inheritance, or a spatial based model parameter inheritance; and
generating the bitstream based on the model parameter inheritance.
